(19) United States
(12) Patent Application Publication
(10) Pub. No.: US 2025/0328017 A1
(43) Pub. Date: Oct. 23, 2025

(54) ELECTRONIC DEVICE

(71) Applicant: Semiconductor Energy Laboratory Co., Ltd., Atsugi-shi, Kanagawa-ken (JP)

(72) Inventors: Ryo HATSUMI, Hadano (JP); Hisao IKEDA, Zama (JP); Daiki NAKAMURA, Atsugi (JP); Takeya HIROSE, Atsugi (JP); Tomotaka NISHIMURA, Kawasaki (JP); Yosuke TSUKAMOTO, Atsugi (JP)

(21) Appl. No.: 18/994,149

(22) PCT Filed: Jul. 11, 2023
(86) PCT No.: PCT/IB2023/057082

§ 371 Date: Jan. 14, 2025

(30) Foreign Application Priority Data
Jul. 22, 2022 (JP) 2022-116868

(51) Int. Cl. G02B 27/01; G02B 27/09

(52) U.S. Cl. CPC G02B 27/0172; G02B 27/0955; G02B 27/0977; G02B 2027/0118; G02B 2027/0178

(57) ABSTRACT

An electronic device with less stray light is provided. The electronic device includes a display panel and an optical device. The optical device has a function of partly decreasing the luminance of light emitted from the display panel. For the optical device, a half mirror, a dark filter, or the like in which the transmittance is continuously decreased from the inside toward the outside can be used. With the use of such a component, stray light that is likely to be generated in a peripheral portion of a lens can be suppressed, and the visibility of an image displayed on the display panel can be improved.

### TECHNICAL FIELD

One embodiment of the present invention relates to an electronic device including an optical device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Accordingly, more specific examples of the technical field of one embodiment of the present invention disclosed in this specification include a semiconductor device, a display device, a liquid crystal display device, a light-emitting apparatus, a lighting device, a power storage device, a memory device, an imaging device, an operation method thereof, and a manufacturing method thereof.

Note that in this specification and the like, a semiconductor device generally means a device that can function by utilizing semiconductor characteristics. A transistor and a semiconductor circuit are embodiments of semiconductor devices. In addition, in some cases, a memory device, a display device, an imaging device, or an electronic device includes a semiconductor device.

### BACKGROUND ART

Goggles-type devices and glasses-type devices have been developed as electronic devices for virtual reality (VR), augmented reality (AR), and the like.

In addition, examples of a display device that can be used for a display panel include, typically, a display device including a liquid crystal element and a display device including an organic EL (Electro Luminescence) element, a light-emitting diode (LED), or the like.

A display device including an organic EL element does not need a backlight that is necessary for a liquid crystal display device; thus, a thin, lightweight, high-contrast, and low-power display device can be achieved. Patent Document 1, for example, discloses an example of a display device using an organic EL element.

### REFERENCE

### Patent Document

[Patent Document 1] Japanese Published Patent Application No. 2018-107444

### SUMMARY OF THE INVENTION

### Problems to be Solved by the Invention

An electronic device used for VR, AR, and the like is a kind of wearable device and is desirably made small in order to have improved portability and wearability. Thus, an optical device that is designed to have a short focal length is used for such an electronic device.

The optical device has a structure in which the optical path length is ensured by utilizing polarized light and reflection between components; meanwhile, light reflected by a surface, light whose polarization state is collapsed, or the like attributed to an optical component is generated in some cases. Such stray light deviates from a normal optical path and is incident on a user's eye, and is seen as stray light. Stray light is one factor that deteriorates the quality of an image to be seen.

Thus, an object of one embodiment of the present invention is to provide an electronic device with less stray light. Another object is to provide an electronic device with which a user can see an image with high quality. Another object is to provide a small and thin electronic device. Another object is to provide a novel electronic device.

Note that the description of these objects does not preclude the existence of other objects. One embodiment of the present invention does not necessarily achieve all these objects. Note that other objects will be apparent from the description of the specification, the drawings, the claims, and the like, and other objects can be derived from the description of the specification, the drawings, the claims, and the like.

### Means for Solving the Problems

One embodiment of the present invention relates to an electronic device with less stray light.

One embodiment of the present invention is an electronic device including a display panel and an optical device. The optical device has a first function of converging light emitted from the display panel and emitting the light to a user's eye and a second function of partly decreasing the luminance of the light emitted from the display panel. An image can be seen while a luminance decrease rate of the light emitted from the display panel is continuously increased from a central region of a visual field to an end of the visual field.

The optical device can include a half mirror including a region in which the transmittance is continuously decreased from the inside toward the outside.

Alternatively, the optical device can include a dark filter including a region in which the transmittance is continuously decreased from the inside toward the outside.

The range of the central region is preferably greater than or equal to 20° and less than or equal to 40° including the center of the visual field.

When the transmittance of the optical device corresponding to the central region is 1, the transmittance of the optical device corresponding to the end of the visual field is preferably higher than or equal to 0.3 and lower than or equal to 0.7.

The display panel preferably includes an organic EL element.

### Effect of the Invention

With one embodiment of the present invention, an electronic device with less stray light can be provided. Alternatively, an electronic device with which a user can see an image with high quality can be provided. Alternatively, a thin and lightweight electronic device can be provided. Alternatively, a novel electronic device can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1A and FIG. 1B are diagrams each illustrating a state where an image displayed on a display panel is seen through an optical device.

FIG. 2 is a diagram illustrating a viewing angle.

FIG. 3 is a diagram illustrating the transmittance of an optical device.

FIG. 4A and FIG. 4B are diagrams each illustrating an optical device.

FIG. 5A and FIG. 5B are diagrams each illustrating an optical device.

FIG. 6A is a diagram illustrating a half mirror. FIG. 6B is a diagram illustrating a dark filter.

FIG. 7A and FIG. 7B are diagrams each illustrating an optical device.

FIG. 8 is a diagram illustrating an electronic device.

FIG. 9A to FIG. 9C are diagrams each illustrating a display device.

FIG. 10A and FIG. 10B are diagrams illustrating a glasses-type device.

FIG. 11A to FIG. 11C are diagrams illustrating a structure example of a display panel.

FIG. 12A and FIG. 12B are diagrams each illustrating a structure example of a display panel.

FIG. 13A to FIG. 13F are diagrams each illustrating a structure example of a pixel.

FIG. 14A and FIG. 14B are diagrams illustrating a structure example of a display panel.

FIG. 15 is a diagram illustrating a structure example of a display panel.

FIG. 16 is a diagram illustrating a structure example of a display panel.

FIG. 17 is a diagram illustrating a structure example of a display panel.

FIG. 18 is a diagram illustrating a structure example of a display panel.

FIG. 19 is a diagram illustrating a structure example of a display panel.

FIG. 20 is a diagram illustrating a structure example of a display panel.

FIG. 21 is a diagram illustrating a structure example of a display panel.

### MODE FOR CARRYING OUT THE INVENTION

Embodiments will be described in detail with reference to the drawings. Note that the present invention is not limited to the following description, and it will be readily understood by those skilled in the art that modes and details of the present invention can be modified in various ways without departing from the spirit and scope of the present invention. Therefore, the present invention should not be construed as being limited to the description of embodiments below. Note that in structures of the invention described below, the same reference numerals are used in common, in different drawings, for the same portions or portions having similar functions, and a repeated description thereof is omitted in some cases. Note that the hatching of the same component that constitutes a drawing is sometimes omitted or changed as appropriate in different drawings.

In addition, even in the case where a single component is illustrated in a circuit diagram, the component may be composed of a plurality of parts as long as there is no functional inconvenience. For example, in some cases, a plurality of transistors that operate as a switch are connected in series or in parallel. Furthermore, in some cases, capacitors are separately arranged in a plurality of positions.

In addition, one conductor has a plurality of functions of a wiring, an electrode, a terminal, and the like in some cases. Even in the case where components are illustrated in a circuit diagram as if they were directly connected to each other, the components may actually be connected to each other through one or more conductors; in this specification, even such a structure is included in the category of direct connection.

### Embodiment 1

In this embodiment, electronic devices according to one embodiment of the present invention will be described.

One embodiment of the present invention is an electronic device such as a goggles-type device or a glasses-type device and includes a display panel and an optical device. The optical device has a function of converging light emitted from the display panel and emitting the light to a user's eye. Furthermore, the optical device has a function of partly decreasing the luminance of the light emitted from the display panel, whereby stray light can be reduced.

Stray light refers to light that is incident on the eye without going through a normal optical path, and is seen as overlapping with a normal image. Stray light is one factor that deteriorates the quality of an image to be seen with an electronic device. Note that stray light appears in an unintended position and thus is also referred to as a ghost.

For the optical device, a half mirror, a dark filter, or the like in which the transmittance is continuously decreased from the inside toward the outside can be used. With the use of such a component, stray light that is likely to be generated in a peripheral portion of a lens can be suppressed, and the visibility of an image displayed on the display panel can be improved.

Note that the optical device included in the electronic device of one embodiment of the present invention has a structure in which a plurality of optical components are combined. A mechanism in which such a structure is included in a housing is simply referred to as a lens. Alternatively, the mechanism is also referred to as a pancake lens in some cases because of its thin shape.

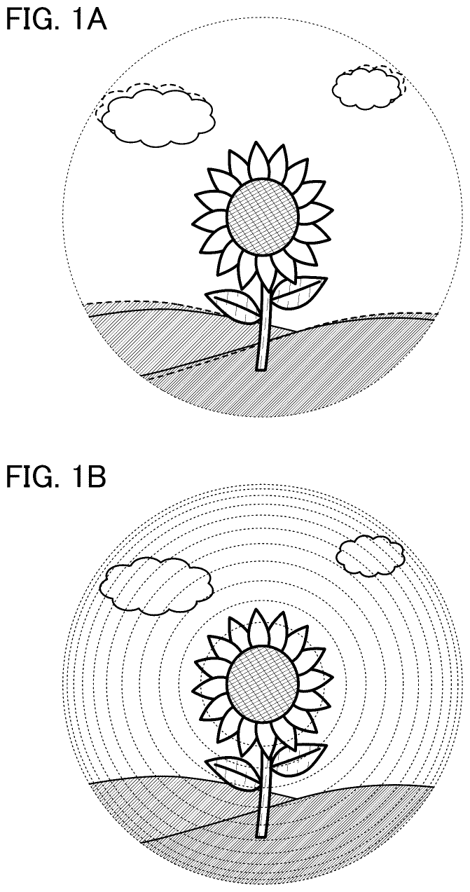

FIG. 1A and FIG. 1B are diagrams each illustrating a state where an image displayed on the display panel is seen through the optical device. Here, dashed lines surrounding the image indicate the end of a visual field. Note that in this embodiment, description is made on the visual field of one eye corresponding to one display panel. The actual visual field is different between the horizontal direction and the vertical direction; thus, the shape is not clear but is described as a circular shape here.

FIG. 1A illustrates a state where the image displayed on the display panel is seen after being magnified by the optical device in which stray light is likely to be generated. Stray light degrades the quality of a visibility condition by causing double images, a blur outline, a bright spot, or the like.

Stray light is more likely to be seen at the periphery of the visual field than at the center of the visual field. This is due to the use of polarized light and due to the curvature of the lens. For a small goggles-type device or the like, a structure in which selective reflection using polarized light or the like can be performed to shorten the focal length is used. In the normal optical path, polarized light passes through a lens and then is reflected by a reflective polarizing plate or the like. However, incident angle of light is large in the peripheral portion of the lens, whereby the polarization state is collapsed in some cases. Part of such polarized light passes through the reflective polarizing plate without being reflected, and deviates from the normal optical path to become stray light.

FIG. 1B illustrates a state where an image similar to that in FIG. 1A is seen with the use of the optical device of one embodiment of the present invention. The optical device of one embodiment of the present invention has a function of, in the optical path, partly decreasing the luminance of the light emitted from the display panel. Specifically, the optical device does not act to decrease the luminance in a central region including the center of the visual field, and continuously acts to decrease the luminance from the end of the central region toward the end of the visual field. In other words, it can be said that the luminance decrease rate of the light emitted from the display panel is continuously increased from the end of the central region toward the end of the visual field.

FIG. 1B illustrates a state where the luminance of the light emitted from the display panel is not decreased in a region of the central portion, and the luminance of the light emitted from the display panel is continuously decreased from the end of the central region toward the end of the visual field as if light is reduced by a gradation filter. As described above, stray light is likely to be generated in the peripheral portion of the lens included in the optical device; meanwhile, when the luminance at the periphery of the visual field corresponding to the peripheral portion of the lens is decreased, the absolute amount of stray light generated can be decreased. Furthermore, in an optical device of one embodiment of the present invention described later, the ratio of stray light to light going through the normal optical path can be decreased.

Here, the visibility in the case where the luminance at the periphery of the visual field is decreased is described. The fovea centralis and its vicinity on the retina of human eyes contribute to high-resolution viewing, whereas a region apart from the fovea centralis on the retina has a lower resolution than the fovea centralis. A technique utilizing the characteristics of human eyes, called foveated rendering, has been proposed: the user's gaze is tracked in image display so that a high-resolution image and a low-resolution image are displayed for the central visual field and the peripheral visual field, respectively.

Lightness and darkness of luminance are similar to the above in a static state; the sensitivity of a portion of the human eye corresponding to the central visual field is high, and the sensitivity of the peripheral visual field is low. That is, as in one embodiment of the present invention, even when the luminance is decreased toward the end of the visual field, a person is less likely to recognize the decrease in the luminance; thus, the person does not feel any discomfort. However, when the luminance is too low, the person starts to recognize the narrow viewing angle. Accordingly, there is an appropriate range for adjusting the luminance in the peripheral visual field.

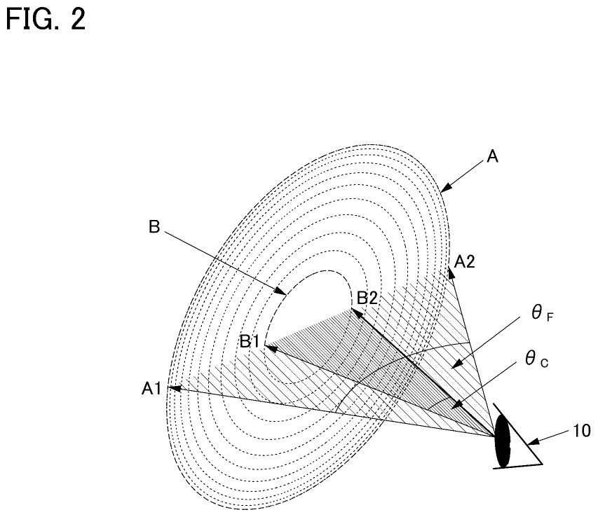

FIG. 2 is a diagram illustrating a viewing angle. When the end of a visual field A (one of points constituting the outer periphery of the visual field A) in the electronic device of one embodiment of the present invention is referred to as A1 and the end of the visual field A opposite to A1 is referred to as A2, an angle formed by two straight lines connecting a human eye 10 and each of A1 and A2 is referred to as θ_{F}. θ_{F} is referred to as a viewing angle. When the end of a central region B (one of points constituting the outer periphery of the central region B) is referred to as B1 and the end of the central region B opposite to B1 is referred to as B2, an angle formed by two straight lines connecting the human eye 10 and each of B1 and B2 is referred to as θ_{C}. θ_{C} is an angle defining the central region B overlapping with the central visual field. The central region B is preferably as large as or larger than the central visual field.

The viewing angle θ_{F}is a value inherent in the electronic device or the human eye. It is found from a sensory test that regardless of the viewing angle θ_{F}, the angle θ_{C} defining the central region B is preferably greater than or equal to 20° and less than or equal to 40°, further preferably greater than or equal to 25° and less than or equal to 35°, and is typically 30°.

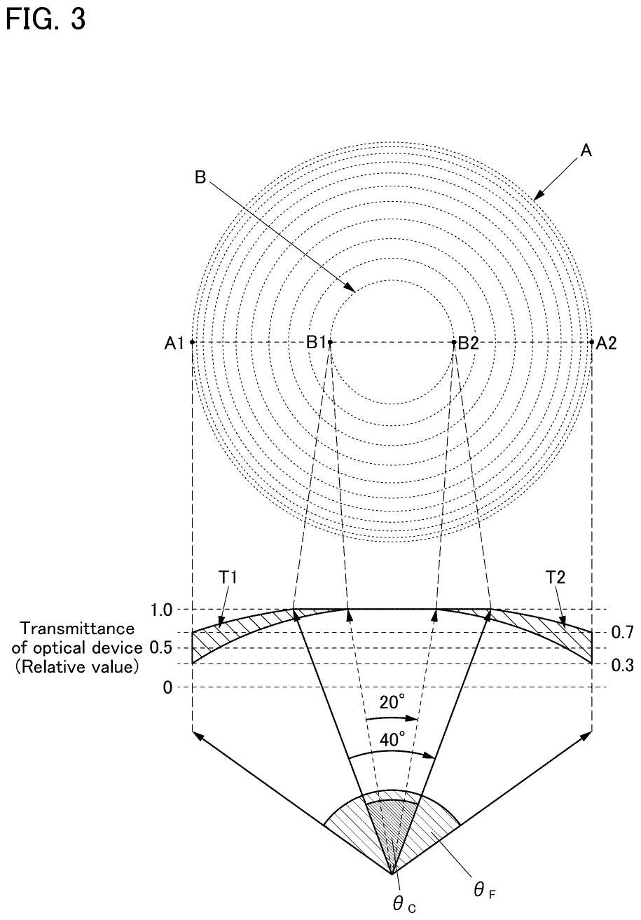

FIG. 3 is a diagram illustrating the transmittance of the optical device within the visual field. Here, the angle θ_{C} defining the central region B can be, for example, 20°≤θ_{C}≤40° from the above. This range includes a region overlapping with the central visual field and is a region where the sensitivity of the human eye is high; thus, the luminance decrease rate with respect to a display image is preferably as low as possible. That is, in a region corresponding to the central region B of the optical device, components for reducing light are not in the optical path so that the transmittance becomes relatively high.

Note that since polarized light and the half mirror are used in the optical device, in some cases, the transmittance is decreased to approximately 10% even when components for reducing light are not in the optical path. Since the transmittance of the optical device varies depending on the structure, description is made here using the relative transmittance with the transmittance of the central region B being 1.

The luminance decrease rate of the display image is continuously increased from the end of the central region B toward the end of the visual field A. That is, the transmittance of the optical device is continuously decreased. In FIG. 3, an appropriate transmittance range T1 which can be set for the end A1 of the visual field A at the shortest distance from the end B1 of the central region B, and an appropriate transmittance range T2 which can be set for the end A2 of the visual field A at the shortest distance from the end B2 of the central region B are indicated by oblique lines.

As illustrated in FIG. 3, when the transmittance at the ends B1 and B2 of the central region B with b 20°≤θ_{C}≤40° is 1, the transmittance at the ends A1 and A2 of the visual field A is preferably continuously decreased to be higher than or equal to 0.3 and lower than or equal to 0.7. This range is set in accordance with the results of the sensory test, and beyond this range, the user feels that stray light is not sufficiently reduced, the viewing angle is narrow, or lightness and darkness of the display to be seen become unnatural, for example. Typically, when θ_{C}=30°, it is preferable that the transmittance be continuously decreased from θ_{C} to θ_{F} such that the transmittance is 0.5 at the ends A1 and A2 of the visual field A.

Note that the decrease in transmittance between B1-A1 and between B2-A2 is likely to take a nonlinear form (a quadratic curve) because a transmission path and a reflection path of the half mirror are included in the normal optical path of the optical device, but may take a linear form. The transmittance is not limited to being changed continuously, and may be changed gradually so as not to affect visibility.

Next, an optical device having a function of continuously increasing the luminance decrease rate of the light emitted from the display panel will be described. The components having the function are described here, and the structure of the optical device as a whole and the polarization state will be described in detail later. Furthermore, reflection, transmission, absorption, and the like other than the main action of each component are ignored, and transmission and reflection of incident light in the normal optical path and generation of stray light are described.

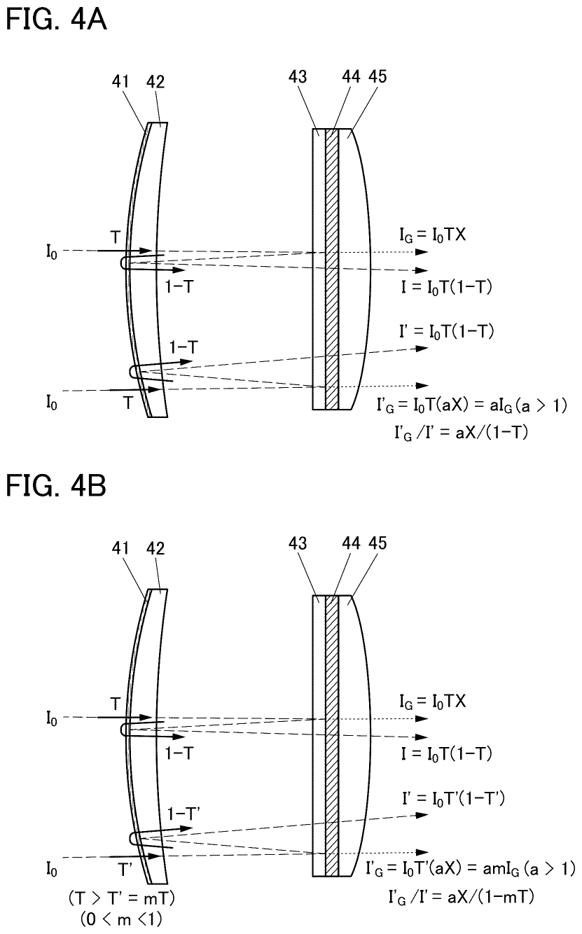

FIG. 4A is a cross-sectional view illustrating part of an optical device, which is a comparative example, where the partial decrease in luminance or the like is not performed and stray light is likely to be seen. The optical device includes a half mirror 41, a lens 42, a retardation plate 43, a reflective polarizing plate 44, and a lens 45. Note that although an example in which the half mirror 41 is provided on one surface of the lens 42 is illustrated, the half mirror 41 may be formed on a support other than the lens 42.

The incident light passes through the half mirror 41 and the lens 42 and is reflected by the reflective polarizing plate 44. At this time, due to collapse of the polarizing state attributed to the lens 42, part of light passes through the reflective polarizing plate 44 and the lens 45 to become stray light.

The amount of stray light I_{G} generated in the vicinity of the center (the vicinity of the central visual field) of the optical device is the product of the amount of incident light I₀, the transmittance T of the half mirror, and the proportion X of light passing through the reflective polarizing plate (I_{G}=I₀×T×X (Formula 1)).

When the value of X is a times (a>1) higher at the periphery of the lens 42 than in the vicinity of the center, the amount of stray light I′_{G} generated at the periphery of the lens is the product of the amount of incident light I₀, the transmittance T of the half mirror, and the proportion aX of light passing through the reflective polarizing plate (I′_{G}=I₀×T×aX (Formula 2)).

The light that is reflected by the reflective polarizing plate 44 and goes through the normal optical path is reflected by the half mirror 41, and is converted into polarized light and passes through the reflective polarizing plate 44 and the lens 45.

The amount of light I (the amount of light in the normal optical path) passing through the reflective polarizing plate 44 in the vicinity of the center of the optical device is the product of the amount of incident light I₀, the transmittance T of the half mirror, and the reflectance (1−T) of the half mirror (I=I₀×T×(1−T)). Although there is actually a loss of X described above, the loss is ignored here assuming that X is a small value.

Since the amount of light in the normal optical path is not dependent on the position of the lens, the amount of light I′ passing through the reflective polarizing plate 44 at the periphery of the lens 42 is the same as the amount of light I(I′=I₀×T×(1−T) (Formula 3)).

Here, according to Formula 1 and Formula 2, I′_{G}=aI_{G}, which means that the amount of stray light is a times (a>1) larger at the periphery of the lens 42 than in the vicinity of the center.

According to Formula 2 and Formula 3, at the periphery of the lens 42, the ratio of the amount of stray light to the amount of light in the normal optical path is expressed as I′_{G}/I′=(I₀×T×aX)/(I₀×T×(1−T))=aX/(1−T).

Next, a structure illustrated in FIG. 4B is described as Structure example 1 of one embodiment of the present invention. The basic structure is similar to that in FIG. 4A, but there is a difference in that the transmittance (T′) of the peripheral portion of the half mirror 41 is lower than the transmittance (T) of the vicinity of the center corresponding to the central region B illustrated in FIG. 2 and FIG. 3 (T>T′).

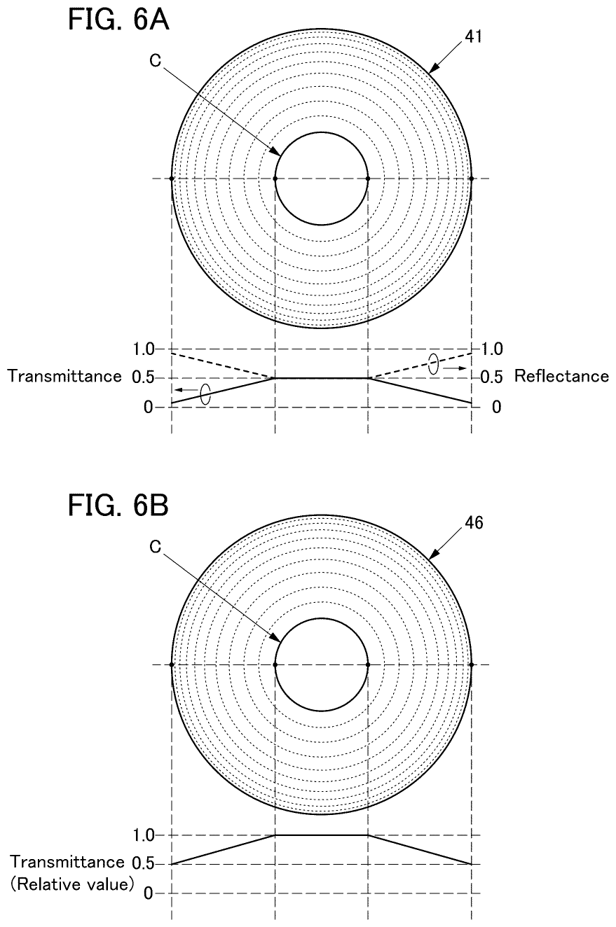

In order to obtain the transmittance of the half mirror 41 with such a structure, as illustrated in a front view of FIG. 6A, for example, the transmittance of a region C corresponding to the central region B is set to 0.5 and the transmittance is continuously decreased toward the end portion. Note that the transmittance of the optical device as a whole can be decreased also by increasing the transmittance of the half mirror 41 to be higher than 0.5 toward the end portion; however, since stray light is increased according to Formula 2, the transmittance of the half mirror 41 is decreased to be lower than 0.5 toward the end portion.

Since transmittance+reflectance=1, the amount of light in the normal path in the half mirror 41 is a quadratic function of the transmittance T; thus, the midpoint is an extremum. That is, the transmittance of the region C becomes the maximum when the transmittance is 0.5 and the reflectance is 0.5. Note that the end of the visual field A illustrated in each of FIG. 2 and FIG. 3 is not limited to the outer periphery of the half mirror 41 and may be inside the outer periphery.

Such a half mirror can be formed in such a manner that a metal film or a dielectric film formed on the support is etched with the use of a gray-tone resist mask so as to have a thickness gradient in the plane. Alternatively, the half mirror can be formed by performing a film formation step a plurality of times with the use of a metal mask or the like having different aperture sizes.

As in Formula 1, the amount of stray light I_{G} generated in the vicinity of the center of the optical device is expressed as I_{G}=I₀×T×X (Formula 4).

When the value of X is a times (a>1) higher at the periphery of the lens 42 than in the vicinity of the center, the amount of stray light I′_{G} is expressed as I′_{G}=I₀×T′×aX (Formula 5).

Here, on the assumption that T′=mT (0<m<1) in consideration of T>T′, according to Formula 4 and Formula 5, I′_{G}=I₀×mT×aX=amI_{G}. In the structure in FIG. 4A, I′_{G}=aI_{G} and m is smaller than 1, which means that the amount of stray light generated at the periphery of the lens 42 is smaller in the structure illustrated in FIG. 4B than in the comparative example illustrated in FIG. 4A.

As in the comparative example in FIG. 4A, the amount of light I (the amount of light in the normal optical path) passing through the reflective polarizing plate 44 in the vicinity of the center of the optical device is I=I₀×T×(1−T).

The amount of light I′ passing through the reflective polarizing plate 44 at the periphery of the lens 42 is I′=I₀×T′×(1−T′) (Formula 6).

According to Formula 5 and Formula 6, at the periphery of the lens 42, the ratio of the amount of stray light to the amount of light in the normal optical path is I′G/I′=(I₀×T′×aX)/(I₀×T′×(1−T′))=aX/(1−mT). In the structure in FIG. 4A, I′G/I′=aX/(1−T) and m is smaller than 1, which means that at the periphery of the lens 42, the ratio of the amount of stray light to the amount of normal light is lower in the structure illustrated in FIG. 4B than in the comparative example illustrated in FIG. 4A.

That is, in the structure illustrated in FIG. 4B, the amount of stray light in the peripheral portion of the lens 42 can be smaller than that in the comparative example illustrated in FIG. 4A. Although the amount of light in the normal optical path in the peripheral portion is smaller than that in the comparative example, the ratio of the amount of stray light to the amount of light in the normal optical path can be lower than that in the comparative example. Thus, the visibility of display can be improved.

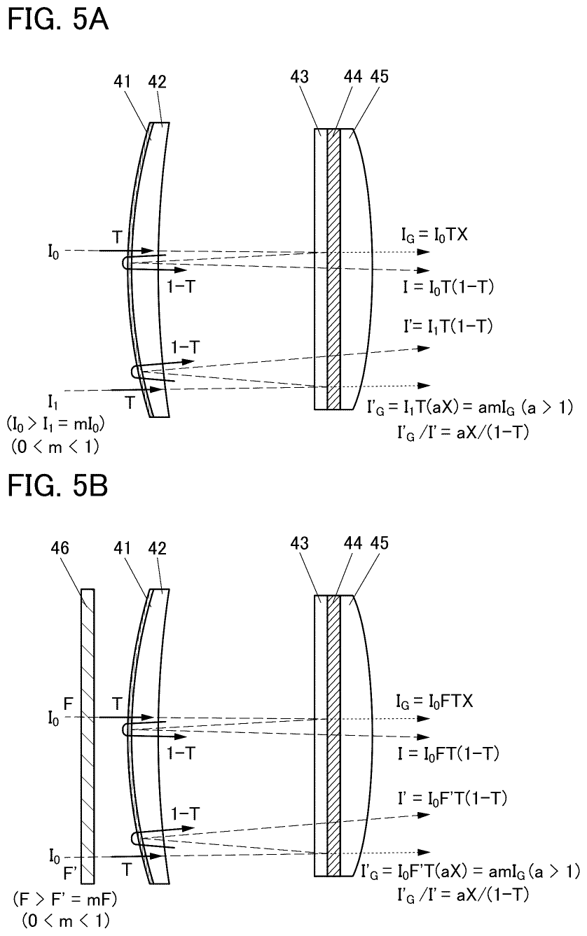

Next, a structure illustrated in FIG. 5A is described as Structure example 2 of one embodiment of the present invention. The basic structure of an optical device is similar to that in FIG. 4A, and a display image obtained by processing data of an original image such that the luminance decrease rate is increased from the vicinity of the center toward the end is used as incident light. Here, the amount of incident light in the vicinity of the center is I₀, and the amount of incident light in the peripheral portion is I₁ (I₀>I₁).

As in Formula 1, the amount of stray light I_{G} generated in the vicinity of the center of the optical device is I₀×T×X (Formula 7).

When the value of X is a times (a>1) higher at the periphery of the lens 42 than in the vicinity of the center, the amount of stray light I′_{G} is expressed as I′_{G}=I₁×T×aX (Formula 8).

Here, on the assumption that I₁=mI₀(0<m<1) in consideration of I₀>I₁, according to Formula 7 and formula 8, I′_{G}=mI₀×T×aX=amI_{G}. In the comparative example illustrated in FIG. 4A, I′_{G}=aI_{G} and m is smaller than 1, which means that the amount of stray light generated at the periphery of the lens 42 is smaller in the structure illustrated in FIG. 5A than in the comparative example illustrated in FIG. 4A.

As in FIG. 4A, the amount of light/(the amount of light in the normal optical path) passing through the reflective polarizing plate 44 in the vicinity of the center of the optical device is expressed as I=I₀×T×(1−T).

The amount of light I′ passing through the reflective polarizing plate 44 at the periphery of the lens 42 is expressed as I′=I₁×T×(1−T)=mI₀×T×(1−T) (Formula 9).

According to Formula 8 and Formula 9, at the periphery of the lens 42, the ratio of the amount of stray light to the amount of light in the normal optical path is expressed as I′G/I′=(I₁×T×aX)/(I₁×T×(1−T))=aX/(1−T).

That is, in the structure illustrated in FIG. 5A, the amount of stray light in the peripheral portion of the lens 42 can be smaller than that in the comparative example illustrated in FIG. 4A. Although the amount of light in the normal optical path is small in the peripheral portion of the lens 42, the ratio of the amount of stray light to that of light in the normal optical path is not increased and can be equivalent to that in the comparative example. Thus, the visibility of display can be improved.

Next, a structure illustrated in FIG. 5B is described as Structure example 3 of one embodiment of the present invention. The basic structure is a structure in which a dark filter 46 is added to FIG. 4A. The dark filter 46 can be provided on the incident surface side of the half mirror 41, between the reflective polarizing plate 44 and the lens 45, or on the emission surface side of the lens 45. FIG. 5B illustrates an example in which the dark filter 46 is provided on the incident surface side of the half mirror 41.

Even when the dark filter 46 is provided between the lens 42 and the retardation plate 43, the effect of reducing the amount of stray light can be obtained. However, since light goes through the dark filter in the normal optical path a plurality of times, the ratio of the amount of stray light to the amount of normal light becomes higher than that in other structures. Thus, the dark filter 46 is preferably provided at the above-described position.

The dark filter 46 has a structure in which the transmittance (F′) of the peripheral portion is lower than the transmittance (F) of the vicinity of the center (F>F′). In order to obtain the transmittance of the dark filter 46 with such a structure, for example, as illustrated in FIG. 6B, the transmittance is set to be the highest in the region C corresponding to the central region B and is continuously decreased toward the end portion. For example, when the relative transmittance of the region C is 1, the value of the transmittance of the end portion can be smaller than 1, e.g., 0.5. Note that the end of the visual field A illustrated in each of FIG. 2 and FIG. 3 is not limited to the outer periphery of the dark filter 46 and may be inside the outer periphery.

The amount of stray light I_{G} generated in the vicinity of the center of the optical device is expressed as I_{G}=I₀×F×T×X (Formula 10).

When the proportion of light passing through the reflective polarizing plate is a times (a>1) higher at the periphery of the lens than in the vicinity of the center, the amount of stray light I′_{G} is expressed as I′_{G}=I₀×F′×T×aX (Formula 11).

Here, on the assumption that F′=mF (0<m<1) in consideration of F>F′, according to Formula 10 and Formula 11, I′_{G}=I₀×mF×T×aX=amI_{G}. In the comparative example illustrated in FIG. 4A, I′_{G}=aI_{G} and m is smaller than 1, which means that the amount of stray light generated at the periphery of the lens 42 is smaller in the structure illustrated in FIG. 5B than in the comparative example illustrated in FIG. 4A.

The amount of light I (the amount of light in the normal optical path) passing through the reflective polarizing plate 44 in the vicinity of the center of the optical device is expressed as I=I₀×F×T×(1−T).

The amount of light I′ passing through the reflective polarizing plate 44 at the periphery of the lens 42 is expressed as I′=I₀×F′×T×(1−T)=I₀×mF×T×(1−T) (Formula 12).

According to Formula 11 and Formula 12, at the periphery of the lens 42, the ratio of the amount of stray light to the amount of light in the normal optical path is expressed as I′_{G}/I′=(I₀×F′×T×aX)/(I₀×F′×T×(1−T))=aX/(1−T).

That is, in the structure illustrated in FIG. 5B, the amount of stray light in the peripheral portion of the lens 42 can be smaller than that in the comparative example illustrated in FIG. 4A. Although the amount of light in the normal optical path is small in the peripheral portion of the lens 42, the ratio of stray light to the amount of light in the normal optical path is not increased and can be equivalent to that in the comparative example. Thus, the visibility of display can be improved.

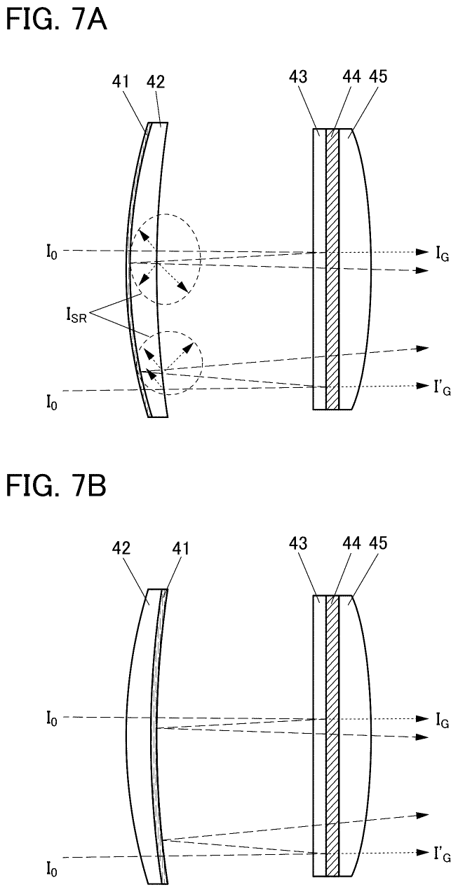

Although the stray light (I_{G} and I′_{G}) passing through the reflective polarizing plate 44 is described with reference to FIG. 4A to FIG. 5B, light I_{SR} reflected by the surface (a second surface) of the lens 42 may also become stray light, as illustrated in FIG. 7A. In the case where the half mirror 41 is formed on a first surface of the lens 42, light passes through the second surface of the lens 42 in the normal optical path three times; thus, the influence of surface reflection is likely to increase.

Thus, in the case where the amount of stray light attributed to the light I_{SR} is large, the half mirror 41 may be provided on the second surface of the lens 42 as illustrated in FIG. 7B. With the structure illustrated in FIG. 7B, light passes through the second surface of the lens 42 one time; thus, the influence of surface reflection is likely to decrease, and stray light can be reduced. The structure illustrated in FIG. 7B can be employed for the structures illustrated in FIG. 4B to FIG. 5C.

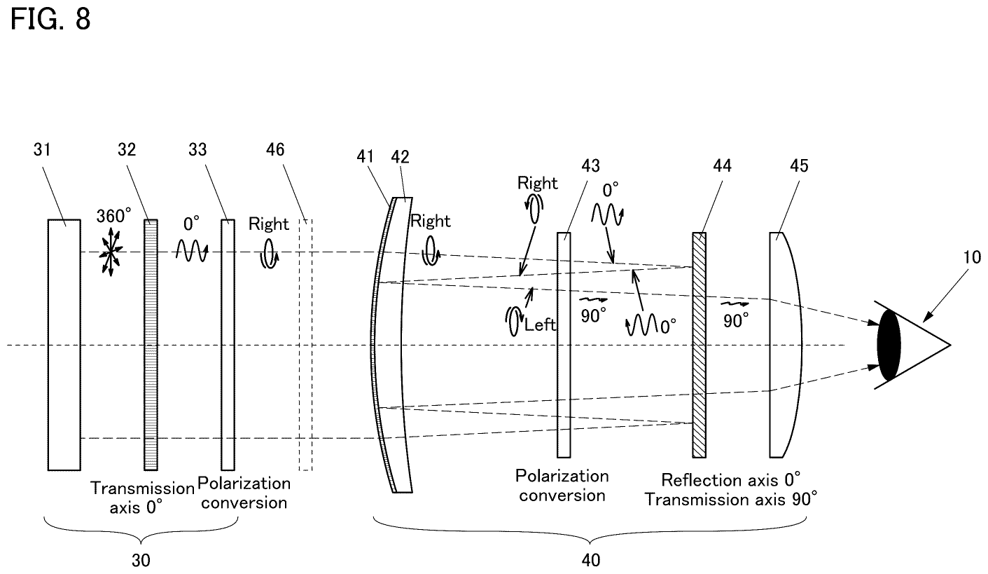

FIG. 8 is a diagram illustrating an electronic device including a display device 30 and an optical device 40, and indicates parts of optical paths with dashed lines. In addition, for clarity, some components that can be placed to be close to each other are illustrated as being apart from each other. Note that the case of using the structure described with reference to FIG. 4B is mainly described here.

A user can see an image displayed on the display device 30 when bringing the eye 10 near the optical device 40. The user sees the image while a viewing angle is widened by the optical device 40, and thus can obtain a sense of immersion and a realistic sensation.

The display device 30 has a structure in which a display panel 31, a linear polarizing plate 32, and a retardation plate 33 are placed to have a region where they overlap with each other. Note that a first surface in the following description refers to one surface of each component, and a second surface refers to a surface opposite to the first surface.

For example, a first surface of the linear polarizing plate 32 can be close to a display portion 34 of the display panel 31 and a second surface of the linear polarizing plate 32 can be close to a first surface of the retardation plate 33. Note that the combination of the linear polarizing plate 32 and the retardation plate 33 is also referred to as a circular polarizing plate that converts unpolarized light to circularly polarized light.

Note that the linear polarizing plate 32 and the retardation plate 33 are not necessarily components of the display device 30, and may be placed between the display device 30 (the display panel 31) and the optical device 40. Alternatively, the linear polarizing plate 32 and the retardation plate 33 may be placed on the light incident surface side of the optical device 40 (the incident surface side of the half mirror 41) as components of the optical device 40. Alternatively, the linear polarizing plate 32 may be a component of the display device 30 and the retardation plate 33 may be a component of the optical device 40.

The optical device 40 has a region where the half mirror 41, the lens 42, the retardation plate 43, the reflective polarizing plate 44, and the lens 45 overlap with each other. An optical axis of the lens 42 and the lens 45 is placed to intersect perpendicularly with a display portion of the display panel 31. In the case where the dark filter 46 is provided, the dark filter 46 is preferably provided on the incident surface side of the half mirror 41, between the reflective polarizing plate 44 and the lens 45, or on the emission surface side of the lens 45. FIG. 8 illustrates an example in which the dark filter 46 is provided on the incident surface side of the half mirror 41.

Note that the term “perpendicular” indicates that the angle formed between two straight lines is greater than or equal to 85° and less than or equal to 95°. Here, one of the two straight lines refers to the optical axis of the lens 42 and the lens 45 and the other refers to a straight line parallel to the display portion (display surface).

For example, a first surface of the half mirror 41 can be close to the first surface of the lens 42. Furthermore, a first surface of the reflective polarizing plate 44 can be close to a first surface of the retardation plate 43, and a first surface of the lens 45 can be close to a second surface of the reflective polarizing plate 44.

The half mirror 41 and the lens 42 may be placed to be apart from each other in order that a necessary optical path length can be ensured. Alternatively, the lens 42 and the retardation plate 43 may be placed close to each other.

In the case where the above structure in which one component and another component are close to each other is employed, the components are preferably bonded to each other with the use of an optical adhesive which has high transmittance of the wavelength of light used (e.g., the wavelength range of visible light or the wavelength range from blue light to red light) and which does not cause birefringence and absorption of particular polarized light. Alternatively, the another component may be formed on and in contact with the one component not by attachment but by a coating method or the like. Alternatively, without using an adhesive or the like between the one component and the another component, the components may be placed in contact with each other. Alternatively, a space may be provided between the one component and the another component.

Note that the effect of one embodiment of the present invention can be obtained also by placing the components included in the display device 30 or the optical device 40 to be apart from each other as in FIG. 8.

Part of light emitted from the display panel 31 passes through the linear polarizing plate 32, the retardation plate 33, the half mirror 41, the lens 42, and the retardation plate 43, and is reflected by the reflective polarizing plate 44. The light reflected by the reflective polarizing plate 44 passes through the retardation plate 43 and the lens 42, and is reflected again by the half mirror 41. The light reflected by the half mirror 41 passes through the lens 42, the retardation plate 43, the reflective polarizing plate 44, and the lens 45, and is converged and to be emitted to the eye 10.

By repeating reflection in the optical device 40 in this manner, the optical path length can be secured; thus, an optical system with a short focal length can be achieved.

A liquid crystal panel including a liquid crystal element, an organic EL panel including an organic EL element, an LED panel including a micro LED (Light Emitting Diode), or the like can be used as the display panel 31. In particular, an organic EL panel is preferably used because a self-luminous and high-resolution display portion is easily formed. In this specification and the like, a light-emitting diode whose chip area is less than or equal to 10000 μm² is referred to as a micro LED. Note that the LED panel is not limited to the micro LED; for example, a light-emitting diode whose chip area is greater than 10000 μm² and less than or equal to 1 mm² (also referred to as a mini LED) may be used.

The linear polarizing plate 32 can extract one linearly polarized light from light oscillating in 360° all directions. Note that although a description is given in this embodiment on the assumption that the transmission axis of the linear polarizing plate 32 is 0°, 0° is not an absolute value but a reference value. That is, the polarization plane of the linearly polarized light extracted by the linear polarizing plate 32 is regarded as 0°. Accordingly, for example, 90° linearly polarized light in this embodiment refers to linearly polarized light obtained by rotating the polarization plane of the linearly polarized light extracted by the linear polarizing plate 32 by 90°.

The retardation plate 33 has a function of converting linearly polarized light into circularly polarized light. Here, a λ/4 plate (a quarter-wave plate) is used as the retardation plate 33. The λ/4 plate is overlaid with the linear polarizing plate 32 such that the angle of the slow axis of the λ/4 plate with respect to the axis of the linear polarized light emitted from the linear polarizing plate 32 becomes 45°, whereby dextrorotatory polarized light (right circularly polarized light) is obtained. The λ/4 plate is overlaid with the linear polarizing plate 32 such that the angle of the slow axis of the λ/4 plate with respect to the axis of the linearly polarized light emitted from the linear polarizing plate 32 becomes −45°, whereby levorotatory circularly polarized light (left circularly polarized light) is obtained. In one embodiment of the present invention, either right circularly polarized light or left circularly polarized light may be used as long as the combination with the characteristics of the reflective polarizing plate 44 described later is appropriate.

The half mirror 41 can have a structure in which, for example, an optical glass or optical resin material with high visible light transmittance is used as a support and a surface provided with a metal film or a dielectric film is used as a reflection surface. A structure illustrated in FIG. 6A can be employed for the half mirror 41.

The reflection surface of the half mirror 41 preferably has positive refractive power in order to converge light toward the direction of the eye 10. Thus, a surface used for the reflective action of the half mirror 41 is preferably a concave surface. Here, an example in which a convex meniscus lens is used as the lens 42 and the half mirror 41 is provided on one surface of the convex meniscus lens is illustrated. Note that the half mirror 41 may be provided on a support other than the lens 42.

A convex lens can be used as the lens 42. Although FIG. 8 illustrates an example where the convex meniscus lens is used as the lens 42, the lens 42 is not limited thereto. For example, the lens 42 may be formed of one or more plano-convex lenses. In addition, a biconvex lens may be used as the lens 42. Alternatively, the lens 42 can be formed by combining lenses selected from a biconvex lens, a plano-convex lens, a biconcave lens, a plano-concave lens, a convex meniscus lens, and a concave meniscus lens. The lens 42 is not limited to a spherical lens and may be an aspherical lens.

Note that a lens similar to the lens 42 can also be used as the lens 45. The optical device 40 may be provided with a lens other than the lenses 42 and 45.

The retardation plate 43 has a function of reversibly converting linearly polarized light and circularly polarized light. The λ/4 plate (a quarter-wave plate) can be used as the retardation plate 43 as well as the retardation plate 33.

The reflective polarizing plate 44 can transmit linearly polarized light whose oscillating direction coincides with the transmission axis, and can reflect linearly polarized light that is orthogonal to the transmission axis. For example, a wire grid polarizing plate or a dielectric multilayer film can be used as the reflective polarizing plate.

Details of the polarization state in the optical device 40 described above are described with reference to the optical path illustrated in FIG. 8.

Light oscillating in 360° all directions that is emitted from the display panel 31 is incident on the linear polarizing plate 32. The transmission axis of the linear polarizing plate 32 is 0°, and 0° linearly polarized light is emitted from the linear polarizing plate 32.

The 0° linearly polarized light emitted from the linear polarizing plate 32 is converted into right circularly polarized light by the retardation plate 33. The right circularly polarized light emitted from the retardation plate 33 passes through the half mirror 41 and is incident on the lens 42.

The right circularly polarized light emitted from the lens 42 is incident on the retardation plate 43 and is converted into 0° linearly polarized light. The 0° linearly polarized light emitted from the retardation plate 43 is reflected by the reflective polarizing plate 44 whose reflection axis is 0°, and the light is incident on the retardation plate 43 and is converted into right circularly polarized light.

The right circularly polarized light emitted from the retardation plate 43 passes through the lens 42 and is reflected by the half mirror 41 to be inverted to left circularly polarized light. The left circularly polarized light inverted by the half mirror 41 passes through the lens 42, and the light is incident on the retardation plate 43 and is converted into 90° linearly polarized light. The 90° linearly polarized light emitted from the retardation plate 43 passes through the reflective polarizing plate 44 whose transmission axis is 90° and the lens 45, and is incident on the eye 10.

With the use of linearly polarized light, circularly polarized light, the half mirror, and the reflective polarizing plate in this manner, reflection and transmission can be selectively performed. Therefore, the optical path length can be secured in a limited space, and the focal length of the optical device can be shortened.

Note that although right circularly polarized light is used as the light that passes through the half mirror 41 and is incident on the lens 42 in the above-described example, left circularly polarized light may be used.

Note that the structure of each of the display device 30 and the optical device 40 illustrated in FIG. 8 is an example, and other structures can also be employed.

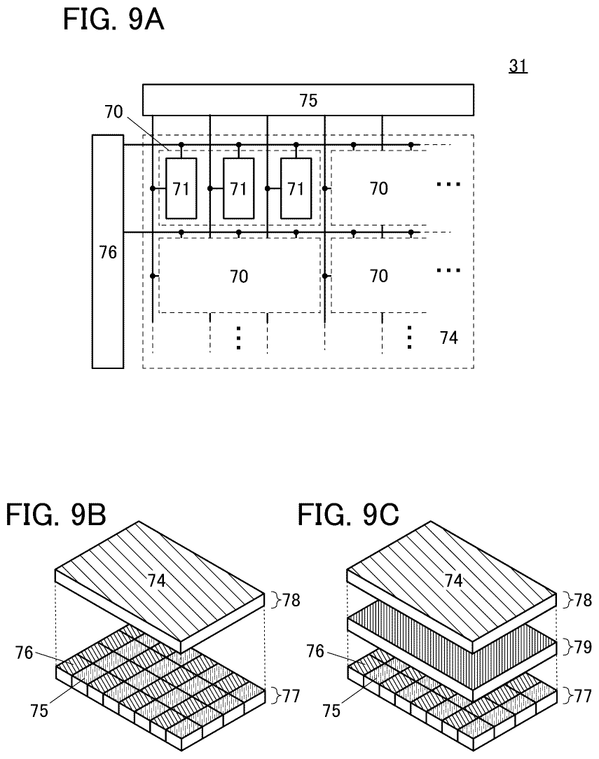

FIG. 9A is a diagram illustrating the display panel 31 included in the electronic device according to one embodiment of the present invention. The display panel 31 includes a pixel array 74, a circuit 75, and a circuit 76. The pixel array 74 includes pixels 70 arranged in a column direction and a row direction.

The pixel 70 can include a plurality of subpixels 71. The subpixel 71 has a function of emitting light for display.

Note that in this specification, although the minimum unit in which an independent operation is performed in one “pixel” is defined as a “subpixel” in the description for convenience, a “pixel” may be replaced with a “region” and a “subpixel” may be replaced with a “pixel.”

The subpixel 71 includes a light-emitting device that emits visible light. An EL element such as an OLED (Organic Light Emitting Diode) or a QLED (Quantum-dot Light Emitting Diode) is preferably used as the light-emitting device. As a light-emitting substance contained in the EL element, a substance that emits fluorescent light (a fluorescent material), a substance that emits phosphorescent light (a phosphorescent material), a substance that exhibits thermally activated delayed fluorescence (a thermally activated delayed fluorescent (TADF) material), an inorganic compound (a quantum dot material or the like), and the like can be given. In addition, an LED such as a micro LED can be also used as the light-emitting device.

The circuit 75 and the circuit 76 are driver circuits for driving the subpixel 71. The circuit 75 can have a function of a source driver circuit, and the circuit 76 can have a function of a gate driver circuit. A shift register circuit or the like can be used as each of the circuit 75 and the circuit 76, for example.

Note that as illustrated in FIG. 9B, a structure where the circuit 75 and the circuit 76 are provided in a layer 77, the pixel array 74 is provided in a layer 78, and the layer 77 and the layer 78 overlap with each other may be employed. This structure enables a display device with a narrow bezel to be formed.

In addition, when the driver circuits are provided below the pixel array 74, wiring length can be shortened and wiring capacitance can be reduced. Accordingly, a display panel capable of a high-speed operation with low power consumption can be provided.

In addition, when each of the circuit 75 and the circuit 76 is divided and arranged as illustrated in FIG. 9B, part of the pixel array 74 can be driven. For example, part of image data in the pixel array 74 can be rewritten. Furthermore, part of the pixel array 74 can be operated at different operating frequency.

The layout and area of the circuit 75 and the circuit 76 illustrated in FIG. 9B are examples and can be changed as appropriate. In addition, parts of the circuit 75 and the circuit 76 can be formed in the same layer as the pixel array 74. Furthermore, a circuit such as a memory circuit, an arithmetic circuit, or a communication circuit may be provided in the layer 77.

In this structure, for example, the layer 77 can be provided on a single crystal silicon substrate, the circuit 75 and the circuit 76 can be formed with transistors including silicon in channel formation regions (hereinafter Si transistors), and pixel circuits included in the pixel array 74 provided in the layer 78 can be formed with transistors including a metal oxide in channel formation regions (hereinafter OS transistors). An OS transistor can be formed with a thin film and can be formed to be stacked over a Si transistor.

Note that as illustrated in FIG. 9C, a structure where a layer 79 including OS transistors is provided between the layer 77 and the layer 78 may be employed. Some of the pixel circuits included in the pixel array 74 in the layer 79 can be provided with OS transistors. Alternatively, some of the circuit 75 and the circuit 76 can be provided with OS transistors. Alternatively, some of the circuits that can be provided in the layer 77, such as a memory circuit, an arithmetic circuit, and a communication circuit, can be provided with OS transistors.

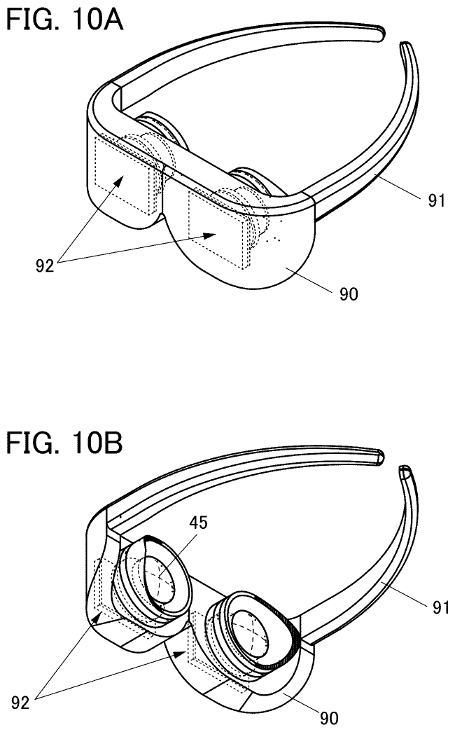

FIG. 10A and FIG. 10B are diagrams illustrating an example of a glasses-type device including the display device 30 and the optical device 40 which are illustrated in FIG. 1. Here, a combination of the display device 30 and the optical device 40 is shown by dashed lines as a display unit 92. The glasses-type device includes two display units 92 and is sometimes called VR glasses depending on the usage.

The two display units 92 are incorporated in a housing 90 so that surfaces of the lenses 45 are exposed on the inner side. One of the display units 92 is for a right eye, the other of the display units 92 is for a left eye, and each of the display units 92 displays an image using parallax, so that the image can be perceived as a three-dimensional image.

In addition, the housing 90 or a band 91 may be provided with an input terminal and an output terminal. To the input terminal, a cable for supplying a video signal from a video output device or the like, power for charging a battery provided in the housing 90, or the like can be connected. The output terminal can function as, for example, an audio output terminal to which earphones, headphones, or the like can be connected. Note that in the case where audio data can be output by wireless communication or sound is output from an external video output device, the audio output terminal is not necessarily provided.

In addition, a wireless communication module, a memory module, and the like may be provided inside the housing 90 or the band 91. Content to be watched can be downloaded via wireless communication using the wireless communication module and can be stored in the memory module. Accordingly, the user can watch the downloaded content offline.

In addition, a gaze sensor may be provided in the housing 90. For example, operation buttons for power-on, power-off, sleep, volume control, channel change, menu display, selection, decision, and back, and operation buttons for play, stop, pause, fast forward, and fast backward of moving images are displayed and visually recognized, so that the respective operations can be performed.

With the use of the optical device 40 according to one embodiment of the present invention for the glasses-type device, a small and thin electronic device with low power consumption and high reliability can be achieved.

At least part of this embodiment can be implemented in combination with the other embodiments described in this specification as appropriate.

### Embodiment 2

In this embodiment, structure examples of a display panel that can be employed for the electronic device according to one embodiment of the present invention will be described. A display panel described below as an example can be employed for the display panel 31 in Embodiment 1.

One embodiment of the present invention is a display panel including light-emitting elements (also referred to as light-emitting devices). The display panel includes two or more pixels of different emission colors. The pixels include light-emitting elements. The light-emitting elements each include a pair of electrodes and an EL layer therebetween. The light-emitting elements are preferably organic EL elements (organic electroluminescent elements). Two or more light-emitting elements of different emission colors include EL layers including different light-emitting materials. For example, when three kinds of light-emitting elements that emit red (R), green (G), and blue (B) light are included, a full-color display panel can be achieved.

In the case of manufacturing a display panel including a plurality of light-emitting elements of different emission colors, at least layers (light-emitting layers) including light-emitting materials each need to be formed in an island shape. In the case of separately forming part or the whole of an EL layer, a method for forming an island-shaped organic film by an evaporation method using a shadow mask such as a metal mask is known. However, this method causes a deviation from the designed shape and position of the island-shaped organic film due to various influences such as the accuracy of the metal mask, the positional deviation between the metal mask and a substrate, a warp of the metal mask, and expansion of the outline of a formed film due to vapor scattering, for example; accordingly, it is difficult to achieve a high resolution and a high aperture ratio of the display panel. In addition, the outline of the layer might blur during evaporation, so that the thickness of an end portion might be reduced. That is, the thickness of an island-shaped light-emitting layer might vary from place to place. In addition, in the case of manufacturing a display panel with a large size, a high definition, or a high resolution, a manufacturing yield might be reduced because of low dimensional accuracy of the metal mask and deformation due to heat or the like. Thus, a measure has been taken for a pseudo increase in resolution (also referred to as pixel density) by employing unique pixel arrangement such as PenTile arrangement.

Note that in this specification and the like, the term “island shape” refers to a state where two or more layers formed using the same material in the same step are physically separated from each other. For example, the term “island-shaped light-emitting layer” refers to a state where the light-emitting layer and its adjacent light-emitting layer are physically separated from each other.

In one embodiment of the present invention, fine patterning of EL layers is performed by a photolithography method without using a shadow mask such as a fine metal mask (FMM). Accordingly, it is possible to achieve a display panel with a high resolution and a high aperture ratio, which has been difficult to achieve. Moreover, since the EL layers can be formed separately, it is possible to achieve a display panel that performs extremely clear display with high contrast and high display quality. Note that, fine patterning of the EL layers may be performed using both a metal mask and a photolithography method, for example.

In addition, part or the whole of the EL layer can be physically divided from each other. This can inhibit leakage current flowing between adjacent light-emitting elements through a layer (also referred to as a common layer) shared by the light-emitting elements. Thus, it is possible to prevent crosstalk due to unintended light emission, so that a display panel with extremely high contrast can be achieved. In particular, a display panel having high current efficiency at low luminance can be achieved.

Note that in one embodiment of the present invention, the display panel can be also obtained by combining a light-emitting element that emits the white light with a color filter. In that case, light-emitting elements having the same structure can be used as light-emitting elements provided in pixels (subpixels) that emit light of different colors, which allows all the layers to be common layers. In addition, part or the whole of the EL layer may be divided from each other in a step using a photolithography method. Thus, leakage current through the common layer is inhibited; accordingly, a high-contrast display panel can be achieved. In particular, when an element has a tandem structure where a plurality of light-emitting layers are stacked with a highly conductive intermediate layer therebetween, leakage current through the intermediate layer can be effectively prevented, so that a display panel with high luminance, high resolution, and high contrast can be achieved.

In the case where the EL layer is processed by a photolithography method, part of the light-emitting layer is sometimes exposed to cause degradation. Thus, an insulating layer covering at least a side surface of the island-shaped light-emitting layer is preferably provided. The insulating layer may cover part of a top surface of an island-shaped EL layer. For the insulating layer, a material having a barrier property against water and oxygen is preferably used. For example, an inorganic insulating film that is less likely to diffuse water or oxygen can be used. This can inhibit deterioration of the EL layer and can achieve a highly reliable display panel.

Moreover, between two adjacent light-emitting elements, there is a region (a concave portion) where none of the EL layers of the light-emitting elements is provided. In the case where a common electrode or a common electrode and a common layer are formed to cover the concave portion, a phenomenon where the common electrode is divided by a step at an end portion of the EL layer (such a phenomenon is also referred to as disconnection) might occur, which might cause insulation of the common electrode over the EL layer. In view of this, a local gap between the two adjacent light-emitting elements is preferably filled with a resin layer (also referred to as local filling planarization, or LFP) functioning as a planarization film. The resin layer has a function of a planarization film. This structure can inhibit disconnection of the common layer or the common electrode and can achieve a highly reliable display panel.

More specific structure examples of the display panel according to one embodiment of the present invention will be described below with reference to drawings.

### Structure Example 1

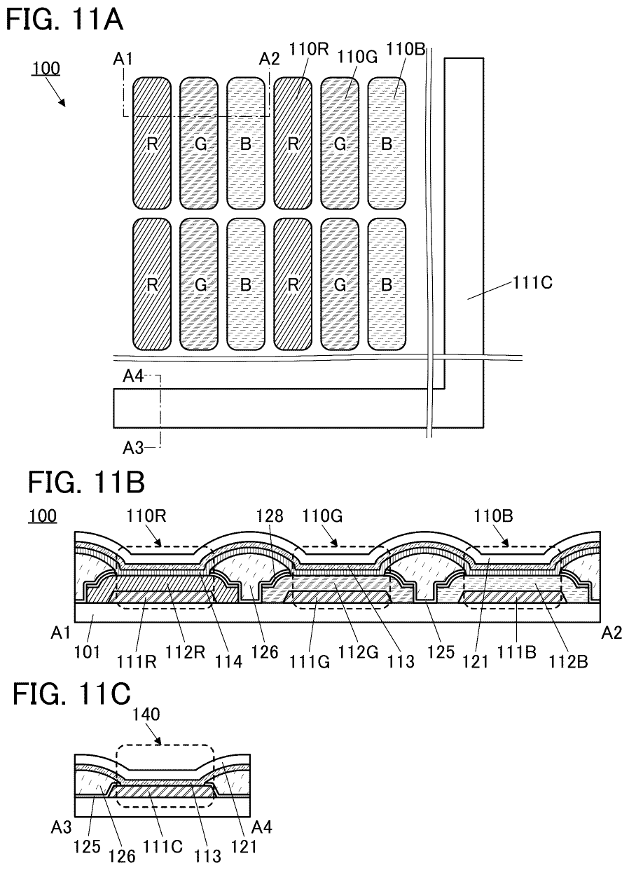

FIG. 11A is a schematic top view of a display panel 100 according to one embodiment of the present invention. The display panel 100 includes, over a substrate 101, a plurality of light-emitting elements 110R exhibiting red, a plurality of light-emitting elements 110G exhibiting green, and a plurality of light-emitting elements 110B exhibiting blue. In FIG. 11A, light-emitting regions of the light-emitting elements are denoted by R, G, and B to easily differentiate the light-emitting elements.

The light-emitting elements 110R, the light-emitting elements 110G, and the light-emitting elements 110B are each arranged in a matrix. FIG. 11A illustrates what is called a stripe arrangement, in which light-emitting elements of the same color are arranged in one direction. Note that an arrangement method of the light-emitting elements is not limited thereto; an arrangement method such as S-stripe arrangement, delta arrangement, Bayer arrangement, or zigzag arrangement may be employed, or PenTile arrangement, diamond arrangement, or the like can be also used.

As each of the light-emitting elements 110R, the light-emitting elements 110G, and the light-emitting elements 110B, an OLED (Organic Light Emitting Diode) or a QLED (Quantum-dot Light Emitting Diode) is preferably used, for example. As the light-emitting substance contained in the EL element, not only an organic compound but also an inorganic compound (a quantum dot material or the like) can be used.

FIG. 11A also illustrates a connection electrode 111C that is electrically connected to a common electrode 113. The connection electrode 111C is supplied with a potential (e.g., an anode potential or a cathode potential) that is to be supplied to the common electrode 113. The connection electrode 111C is provided outside a display region where the light-emitting elements 110R and the like are arranged.

The connection electrode 111C can be provided along the outer periphery of the display region. For example, the connection electrode 111C may be provided along one side of the outer periphery of the display region, or the connection electrode 111C may be provided along two or more sides of the outer periphery of the display region. That is, in the case where the display region has a rectangular top surface shape, the top surface shape of the connection electrode 111C can be a band shape (a rectangle), an L shape, a U shape (a square bracket shape), a quadrangular shape, or the like. Note that in this specification and the like, a top surface shape refers to a shape in a plan view, i.e., a shape seen from above.

FIG. 11B and FIG. 11C are schematic cross-sectional views corresponding to the dashed-dotted line A1-A2 and the dashed-dotted line A3-A4, respectively, in FIG. 11A. FIG. 11B is a schematic cross-sectional view of the light-emitting element 110R, the light-emitting element 110G, and the light-emitting element 110B, and FIG. 11C is a schematic cross-sectional view of a connection portion 140 where the connection electrode 111C and the common electrode 113 are connected to each other.

The light-emitting element 110R includes a pixel electrode 111R, an organic layer 112R, a common layer 114, and the common electrode 113. The light-emitting element 110G includes a pixel electrode 111G, an organic layer 112G, the common layer 114, and the common electrode 113. The light-emitting element 110B includes a pixel electrode 111B, an organic layer 112B, the common layer 114, and the common electrode 113. The common layer 114 and the common electrode 113 are provided to be shared by the light-emitting element 110R, the light-emitting element 110G, and the light-emitting element 110B.

The organic layer 112R included in the light-emitting element 110R contains at least a light-emitting organic compound that emits red light. The organic layer 112G included in the light-emitting element 110G contains at least a light-emitting organic compound that emits green light. The organic layer 112B included in the light-emitting element 110B contains at least a light-emitting organic compound that emits blue light. Each of the organic layer 112R, the organic layer 112G, and the organic layer 112B can be also referred to as an EL layer and includes at least a layer containing a light-emitting substance (a light-emitting layer).

Hereinafter, the term “light-emitting element 110” is sometimes used to describe matters common to the light-emitting element 110R, the light-emitting element 110G, and the light-emitting element 110B. Similarly, in the description of matters common to components that are distinguished from each other using alphabets, such as the organic layer 112R, the organic layer 112G, and the organic layer 112B, reference numerals without alphabets are sometimes used.

Each of the organic layer 112 and the common layer 114 can independently include one or more of an electron-injection layer, an electron-transport layer, a hole-injection layer, and a hole-transport layer. For example, it is possible to employ a structure where the organic layer 112 has a stacked-layer structure of a hole-injection layer, a hole-transport layer, a light-emitting layer, and an electron-transport layer from the pixel electrode 111 side and the common layer 114 includes an electron-injection layer.

The pixel electrode 111R, the pixel electrode 111G, and the pixel electrode 111B are provided for the respective light-emitting elements. In addition, the common electrode 113 and the common layer 114 are each provided as a continuous layer shared by the light-emitting elements. A conductive film having a light-transmitting property with respect to visible light is used for either the pixel electrodes or the common electrode 113, and a conductive film having a reflective property is used for the other. When the pixel electrodes have light-transmitting properties and the common electrode 113 has a reflective property, a bottom-emission display panel can be obtained. In contrast, when the pixel electrodes have reflective properties and the common electrode 113 has a light-transmitting property, a top-emission display panel can be obtained. Note that when both the pixel electrodes and the common electrode 113 have light-transmitting properties, a dual-emission display panel can be obtained.

A protective layer 121 is provided over the common electrode 113 to cover the light-emitting element 110R, the light-emitting element 110G, and the light-emitting element 110B. The protective layer 121 has a function of preventing diffusion of impurities such as water into each light-emitting element from the above.

An end portion of the pixel electrode 111 preferably has a tapered shape. In the case where the end portion of the pixel electrode 111 has a tapered shape, the organic layer 112 that is provided along the end portion of the pixel electrode 111 can also have a tapered shape. When the end portion of the pixel electrode 111 has a tapered shape, coverage with the organic layer 112 provided beyond the end portion of the pixel electrode 111 can be increased. Furthermore, when the side surface of the pixel electrode 111 has a tapered shape, a material (for example, also referred to as dust or particles) in a manufacturing step is easily removed by processing such as cleaning, which is preferable.

Note that in this specification and the like, a tapered shape indicates a shape in which at least part of a side surface of a structure is inclined to a substrate surface. For example, a tapered shape preferably includes a region where an angle formed between the inclined side surface and the substrate surface (such an angle is also referred to as a taper angle) is less than 90°.

The organic layer 112 is processed into an island shape by a photolithography method. Thus, an angle formed between a top surface and a side surface of an end portion of the organic layer 112 is approximately 90°. By contrast, an organic film formed using an FMM or the like has a thickness that tends to gradually decrease with decreasing distance to the end portion, and the top surface has a slope shape in the range of greater than or equal to 1 μm and less than or equal to 10 μm, for example; thus, such an organic film has a shape whose top and side surfaces cannot be easily distinguished from each other.

An insulating layer 125, a resin layer 126, and a layer 128 are included between two adjacent light-emitting elements.

Between two adjacent light-emitting elements, the side surfaces of the organic layers 112 are provided to face each other with the resin layer 126 therebetween. The resin layer 126 is positioned between the two adjacent light-emitting elements and is provided to fill regions between end portions of the organic layers 112 and between the two organic layers 112. The resin layer 126 has a top surface with a smooth convex shape, and the common layer 114 and the common electrode 113 are provided to cover the top surface of the resin layer 126.

The resin layer 126 functions as a planarization film that fills a gap positioned between two adjacent light-emitting elements. Providing the resin layer 126 can prevent a phenomenon in which the common electrode 113 is divided by a step at an end portion of the organic layer 112 (such a phenomenon is also referred to as disconnection) from occurring and the common electrode 113 over the organic layer 112 from being insulated.

An insulating layer containing an organic material can be suitably used as the resin layer 126. For the resin layer 126, an acrylic resin, a polyimide resin, an epoxy resin, an imide resin, a polyamide resin, a polyimide-amide resin, a silicone resin, a siloxane resin, a benzocyclobutene-based resin, a phenol resin, a precursor of these resins, or the like can be used, for example. For the resin layer 126, an organic material such as polyvinyl alcohol (PVA), polyvinylbutyral, polyvinylpyrrolidone, polyethylene glycol, polyglycerin, pullulan, water-soluble cellulose, or an alcohol-soluble polyamide resin may be used.

Alternatively, a photosensitive resin can be used for the resin layer 126. A photoresist may be used for the photosensitive resin. As the photosensitive resin, a positive photosensitive material or a negative photosensitive material can be used.

The resin layer 126 may include a material absorbing visible light. For example, the resin layer 126 itself may be made of a material absorbing visible light, or the resin layer 126 may include a pigment absorbing visible light. For example, for the resin layer 126, it is possible to use a resin that can be used as a color filter transmitting red, blue, or green light and absorbing other light, a resin that contains carbon black as a pigment and functions as a black matrix, or the like.

The insulating layer 125 is provided in contact with the side surface of the organic layers 112. In addition, the insulating layer 125 is provided to cover an upper end portion of the organic layer 112. Furthermore, part of the insulating layer 125 is provided in contact with the top surface of the substrate 101

The insulating layer 125 is positioned between the resin layer 126 and the organic layer 112 and functions as a protective film for preventing contact between the resin layer 126 and the organic layer 112. When the organic layer 112 and the resin layer 126 are in contact with each other, the organic layer 112 might be dissolved in an organic solvent or the like used at the time of forming the resin layer 126. Therefore, the insulating layer 125 is provided between the organic layer 112 and the resin layer 126 to protect the side surfaces of the organic layer 112.

An insulating layer including an inorganic material can be used for the insulating layer 125. For the insulating layer 125, an inorganic insulating film such as an oxide insulating film, a nitride insulating film, an oxynitride insulating film, or a nitride oxide insulating film can be used, for example. The insulating layer 125 may have either a single-layer structure or a stacked-layer structure. Examples of the oxide insulating film include a silicon oxide film, an aluminum oxide film, a magnesium oxide film, an indium gallium zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon oxide film that is formed by an ALD method is used for the insulating layer 125, it is possible to form the insulating layer 125 that has a small number of pinholes and has an excellent function of protecting the EL layer.

Note that in this specification and the like, oxynitride refers to a material that includes more oxygen than nitrogen in its composition, and nitride oxide refers to a material that includes more nitrogen than oxygen in its composition. For example, silicon oxynitride refers to a material that includes more oxygen than nitrogen in its composition, and silicon nitride oxide refers to a material that includes more nitrogen than oxygen in its composition.

For the formation of the insulating layer 125, a sputtering method, a CVD method, a PLD method, an ALD method, or the like can be used. The insulating layer 125 is preferably formed by an ALD method that provides good coverage.

In addition, a structure may be employed in which a reflective film (e.g., a metal film including one or more selected from silver, palladium, copper, titanium, aluminum, and the like) is provided between the insulating layer 125 and the resin layer 126 so that light emitted from the light-emitting layer is reflected by the reflective film. This can improve light extraction efficiency.

The layer 128 is a remaining part of a protective layer (also referred to as a mask layer or a sacrificial layer) for protecting the organic layer 112 during etching of the organic layer 112. For the layer 128, a material that can be used for the insulating layer 125 can be used. It is particularly preferable to use the same material for the layer 128 and the insulating layer 125 because an apparatus or the like for processing can be used in common.

In particular, since a metal oxide film such as an aluminum oxide film or a hafnium oxide film or an inorganic insulating film such as a silicon oxide film that is formed by an ALD method has a small number of pinholes, such a film has an excellent function of protecting the EL layer and can be suitably used for the insulating layer 125 and the layer 128.

The protective layer 121 can have, for example, a single-layer structure or a stacked-layer structure including at least an inorganic insulating film. Examples of the inorganic insulating film include an oxide film and a nitride film, such as a silicon oxide film, a silicon oxynitride film, a silicon nitride oxide film, a silicon nitride film, an aluminum oxide film, an aluminum oxynitride film, and a hafnium oxide film. Alternatively, a semiconductor material or a conductive material such as indium gallium oxide, indium zinc oxide, indium tin oxide, or indium gallium zinc oxide may be used for the protective layer 121.

For the protective layer 121, a stacked film of an inorganic insulating film and an organic insulating film can be used. For example, a structure where an organic insulating film is interposed between a pair of inorganic insulating films is preferable. Furthermore, the organic insulating film preferably functions as a planarization film. This enables the top surface of the organic insulating film to be flat, which results in improved coverage with the inorganic insulating film thereover and a higher barrier property. Moreover, the top surface of the protective layer 121 is flat; therefore, when a component (e.g., a color filter, an electrode of a touch sensor, a lens array, or the like) is provided above the protective layer 121, the component can be less affected by an uneven shape caused by a lower structure.

FIG. 11C illustrates the connection portion 140 in which the connection electrode 111C and the common electrode 113 are electrically connected to each other. In the connection portion 140, an opening portion is provided in the insulating layer 125 and the resin layer 126 over the connection electrode 111C. The connection electrode 111C and the common electrode 113 are electrically connected to each other in the opening portion.

Note that although FIG. 11C illustrates the connection portion 140 in which the connection electrode 111C and the common electrode 113 are electrically connected to each other, the common electrode 113 may be provided over the connection electrode 111C with the common layer 114 therebetween. Particularly in the case where a carrier-injection layer is used as the common layer 114, for example, a material used for the common layer 114 has sufficiently low electrical resistivity and the common layer 114 can be formed to be thin; thus, problems do not arise in many cases even when the common layer 114 is positioned in the connection portion 140. Accordingly, the common electrode 113 and the common layer 114 can be formed with the use of the same shielding mask, so that manufacturing cost can be reduced.

### Structure Example 2

A display panel whose structure is partly different from that of Structure Example 1 is described below. Note that the above description can be referred to for portions common to those in Structure Example 1, and the description is omitted in some cases.

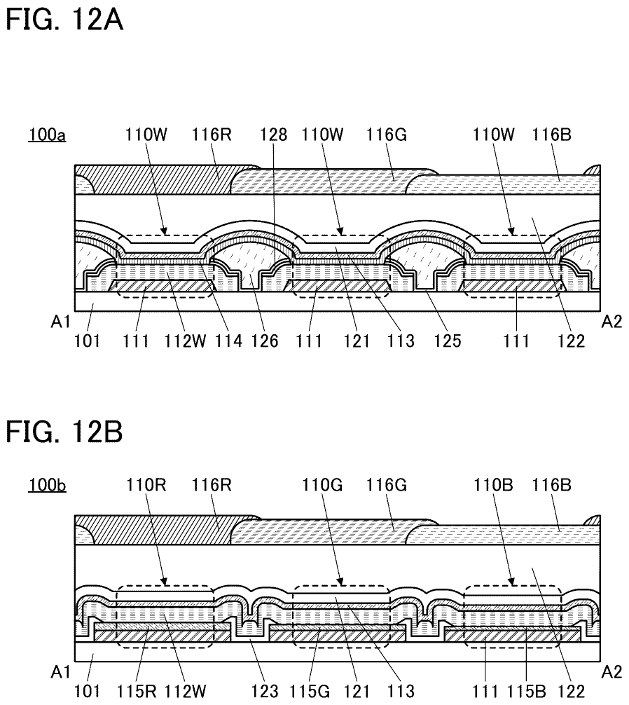

FIG. 12A is a schematic cross-sectional view of a display panel 100a. The display panel 100a is different from the display panel 100 mainly in the structure of the light-emitting element and including a coloring layer.

The display panel 100a includes light-emitting elements 110W that emit white light. The light-emitting elements 110W each include the pixel electrode 111, an organic layer 112W, the common layer 114, and the common electrode 113. The organic layer 112W emits white light. For example, the organic layer 112W can include two or more kinds of light-emitting materials whose emission colors are complementary colors. For example, the organic layer 112W can include a light-emitting organic compound that emits red light, a light-emitting organic compound that emits green light, and a light-emitting organic compound that emits blue light. Alternatively, the organic layer 112W may include a light-emitting organic compound that emits blue light and a light-emitting organic compound that emits yellow light.

The organic layer 112W is divided between two adjacent light-emitting elements 110W. Thus, leakage current flowing between the adjacent light-emitting elements 110W through the organic layer 112W can be inhibited and crosstalk due to the leakage current can be inhibited. Accordingly, the display panel can achieve high contrast and high color reproducibility.

An insulating layer 122 that functions as a planarization film is provided over the protective layer 121, and a coloring layer 116R, a coloring layer 116G, and a coloring layer 116B are provided over the insulating layer 122.

An organic resin film or an inorganic insulating film with a flat top surface can be used for the insulating layer 122. The insulating layer 122 is a formation surface on which the coloring layer 116R, the coloring layer 116G, and the coloring layer 116B are formed; thus, with the flat top surface of the insulating layer 122, the thickness of the coloring layer 116R or the like can be uniform and color purity can be increased. Note that when the thickness of the coloring layer 116R or the like is non-uniform, the amount of light absorption varies depending on a place in the coloring layer 116R, which might decrease the color purity.

### Structure Example 3

FIG. 12B is a schematic cross-sectional view of a display panel 100b.

The light-emitting element 110R includes the pixel electrode 111, a conductive layer 115R, the organic layer 112W, and the common electrode 113. The light-emitting element 110G includes the pixel electrode 111, a conductive layer 115G, the organic layer 112W, and the common electrode 113. The light-emitting element 110B includes the pixel electrode 111, a conductive layer 115B, the organic layer 112W, and the common electrode 113. The conductive layer 115R, the conductive layer 115G, and the conductive layer 115B each have a light-transmitting property and function as an optical adjustment layer.

A film that reflects visible light is used for the pixel electrode 111 and a film having a property of reflecting and transmitting visible light is used for the common electrode 113, so that a micro resonator (microcavity) structure can be achieved. In that case, by adjusting the thicknesses of the conductive layer 115R, the conductive layer 115G, and the conductive layer 115B to obtain optimal optical path length, light with different wavelengths and increased intensities can be obtained from the light-emitting element 110R, the light-emitting element 110G, and the light-emitting element 110B even when the organic layer 112 that emits white light is used.

Furthermore, the coloring layer 116R, the coloring layer 116G, and the coloring layer 116B are provided on the optical paths of the light-emitting element 110R, the light-emitting element 110G, and the light-emitting element 110B, respectively, so that light with high color purity can be obtained.

In addition, an insulating layer 123 that covers end portions of the pixel electrode 111, the conductive layer 115R, the conductive layer 115G, and the conductive layer 115B is provided. An end portion of the insulating layer 123 preferably has a tapered shape. When the insulating layer 123 is provided, coverage with the organic layer 112W, the common electrode 113, the protective layer 121, and the like provided over the insulating layer 123 can be increased.

The organic layer 112W and the common electrode 113 are each provided as one continuous film shared by the light-emitting elements. Such a structure is preferable because the manufacturing process of the display panel can be greatly simplified.

Here, the end portion of the pixel electrode 111 preferably has a substantially vertical shape. Accordingly, a steep portion can be formed on the surface of the insulating layer 123, and thus a thin portion can be formed in part of the organic layer 112W that covers the steep portion or part of the organic layer 112W can be divided. Accordingly, leakage current generated between adjacent light-emitting elements through the organic layer 112W can be inhibited without processing the organic layer 112W by a photolithography method or the like.

The above is the description of the structure example of the display panel.

### Pixel Layout

Pixel layouts different from that in FIG. 11A will be mainly described below. There is no particular limitation on the arrangement of light-emitting elements (subpixels), and a variety of methods can be employed.

In addition, examples of a top surface shape of the subpixel include polygons such as a triangle, a tetragon (including a rectangle and a square), and a pentagon; polygons with rounded corners; an ellipse; and a circle. Here, the top surface shape of the subpixel corresponds to a top surface shape of a light-emitting region of the light-emitting element.

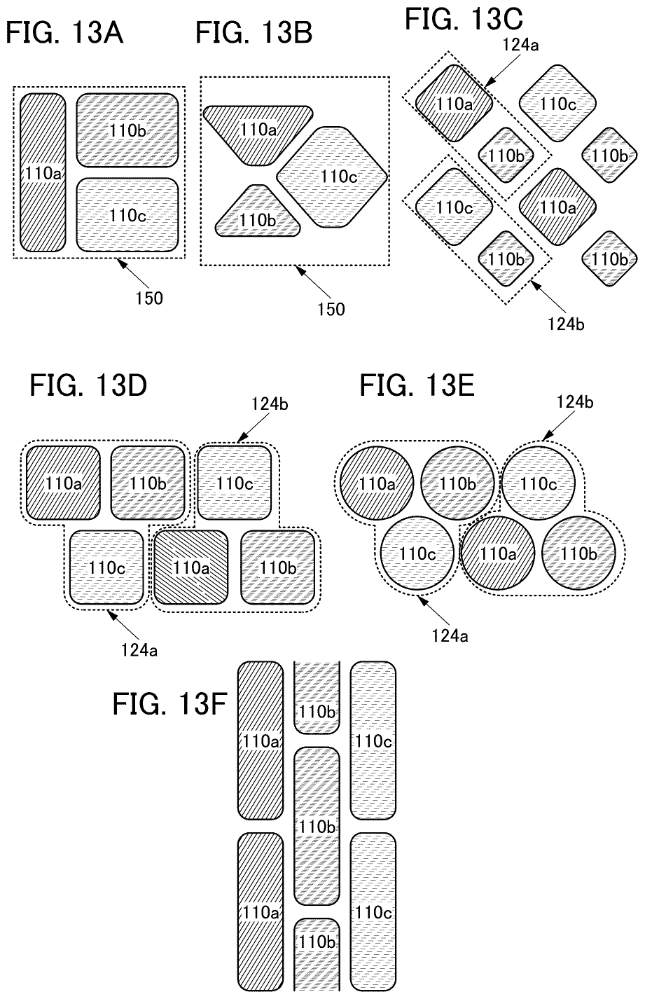

A pixel 150 illustrated in FIG. 13A employs an S-stripe arrangement. The pixel 150 illustrated in FIG. 13A is composed of three subpixels: light-emitting elements 110a, 110b, and 110c. For example, the light-emitting element 110a may be a blue-light-emitting element, the light-emitting element 110b may be a red-light-emitting element, and the light-emitting element 110c may be a green-light-emitting element.

The pixel 150 illustrated in FIG. 13B includes the light-emitting element 110a whose top surface has a rough trapezoidal or rough triangle shape with rounded corners, the light-emitting element 110b whose top surface has a rough trapezoidal or rough triangle shape with rounded corners, and the light-emitting element 110c whose top surface has a rough tetragonal or rough hexagonal shape with rounded corners. In addition, the light-emitting element 110a has a larger light-emitting area than the light-emitting element 110b. In this manner, the shapes and sizes of the light-emitting elements can be independently determined. For example, the size of a light-emitting element with higher reliability can be made smaller. For example, the light-emitting element 110a may be a green-light-emitting element, the light-emitting element 110b may be a red-light-emitting element, and the light-emitting element 110c may be a blue-light-emitting element.

Pixels 124a and 124b illustrated in FIG. 13C employ PenTile arrangement. FIG. 13C illustrates an example where the pixels 124a each including the light-emitting element 110a and the light-emitting element 110b and the pixels 124b each including the light-emitting element 110b and the light-emitting element 110c are alternately arranged. For example, the light-emitting element 110a may be a red-light-emitting element, the light-emitting element 110b may be a green-light-emitting element, and the light-emitting element 110c may be a blue-light-emitting element.

The pixels 124a and 124b illustrated in FIG. 13D and FIG. 13E employ a delta arrangement. The pixel 124a includes two light-emitting elements (the light-emitting elements 110a and 110b) in an upper row (a first row) and one light-emitting element (the light-emitting element 110c) in a lower row (a second row). The pixel 124b includes one light-emitting element (the light-emitting element 110c) in the upper row (the first row) and two light-emitting elements (the light-emitting elements 110a and 110b) in the lower row (the second row). For example, the light-emitting element 110a may be a red-light-emitting element, the light-emitting element 110b may be a green-light-emitting element, and the light-emitting element 110c may be a blue-light-emitting element.

FIG. 13D illustrates an example in which the top surface of each light-emitting element has a rough tetragonal shape with rounded corners, and FIG. 13E illustrates an example in which the top surface of each light-emitting element is circular.

FIG. 13F illustrates an example in which light-emitting elements of different colors are arranged in a zigzag manner. Specifically, the positions of top sides of two light-emitting elements arranged in a column direction (e.g., the light-emitting element 110a and the light-emitting element 110b or the light-emitting element 110b and the light-emitting element 110c) are not aligned in a top view. For example, the light-emitting element 110a may be a red-light-emitting element, the light-emitting element 110b may be a green-light-emitting element, and the light-emitting element 110c may be a blue-light-emitting element.

In a photolithography method, as a pattern to be processed becomes finer, the influence of light diffraction becomes more difficult to ignore; accordingly, fidelity in transferring a photomask pattern by light exposure is degraded, and it becomes difficult to process a resist mask into a desired shape. Thus, a pattern with rounded corners is likely to be formed even with a rectangular photomask pattern. Consequently, the top surface of a light-emitting element has a polygonal shape with rounded corners, an elliptical shape, a circular shape, or the like in some cases.

Furthermore, in a method for manufacturing a display panel according to one embodiment of the present invention, the EL layer is processed into an island shape with the use of a resist mask. A resist film formed over the EL layer needs to be cured at a temperature lower than the upper temperature limit of the EL layer. Thus, the resist film is insufficiently cured in some cases depending on the upper temperature limit of the material of the EL layer and the curing temperature of a resist material. An insufficiently cured resist film might have a shape different from a desired shape at the time of processing. As a result, the top surface of the EL layer has a polygonal shape with rounded corners, an elliptical shape, a circular shape, or the like in some cases. For example, when a resist mask with a square top surface is intended to be formed, a resist mask with a circular top surface might be formed, and the top surface of the EL layer might be circular.

Note that to obtain a desired top surface shape of the EL layer, a technique of correcting a mask pattern in advance so that a transferred pattern agrees with a design pattern (an OPC (Optical Proximity Correction) technique) may be used. Specifically, with the OPC technique, a pattern for correction is added to a corner portion or the like of a figure on a mask pattern.

The above is the description of the pixel layout.

At least part of this embodiment can be implemented in combination with the other embodiments described in this specification as appropriate.

### Embodiment 3

In this embodiment, other structure examples of a display panel that can be employed for the electronic device according to one embodiment of the present invention will be described.

Display panels in this embodiment are high-resolution display panels, and particularly suitably used for display portions of wearable devices that can be worn on a head, such as VR devices like head-mounted displays and glasses-type AR devices.

### Display module

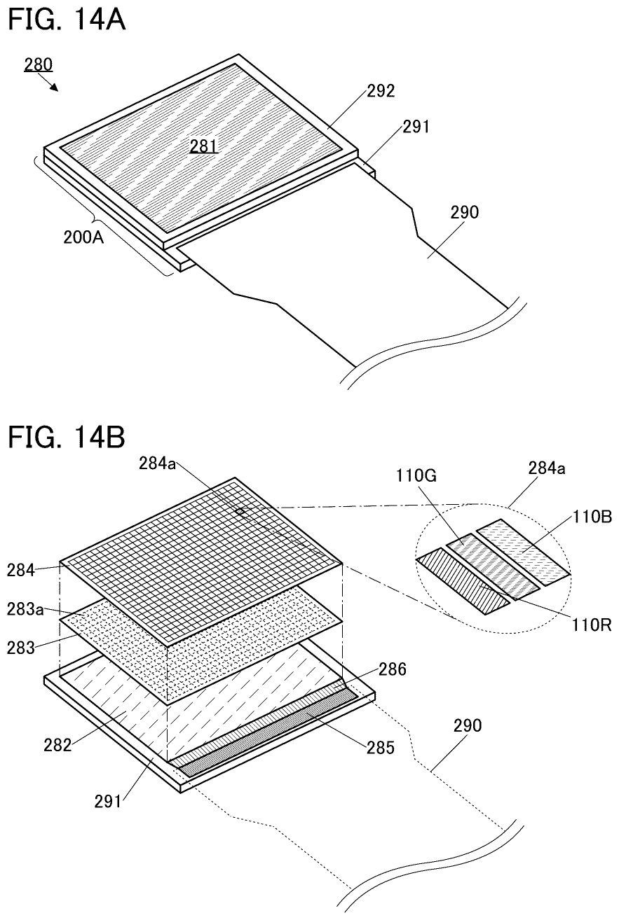

FIG. 14A is a perspective view of a display module 280. The display module 280 includes a display panel 200A and an FPC 290. Note that a display panel included in the display module 280 is not limited to the display panel 200A and may be any of a display panel 200B to a display panel 200F described later.

The display module 280 includes a substrate 291 and a substrate 292. The display module 280 includes a display portion 281. The display portion 281 is a region where an image is displayed.

FIG. 14B is a perspective view schematically illustrating a structure on the substrate 291 side. Over the substrate 291, a circuit portion 282, a pixel circuit portion 283 over the circuit portion 282, and a pixel portion 284 over the pixel circuit portion 283 are stacked. In addition, a terminal portion 285 to be connected to the FPC 290 is provided in a portion that is over the substrate 291 and does not overlap with the pixel portion 284. The terminal portion 285 and the circuit portion 282 are electrically connected to each other through a wiring portion 286 formed of a plurality of wirings.

The pixel portion 284 includes a plurality of pixels 284a arranged periodically. An enlarged view of one pixel 284a is illustrated on the right side of FIG. 14B. The pixel 284a includes the light-emitting element 110R that emits red light, the light-emitting element 110G that emits green light, and the light-emitting element 110B that emits blue light.

The pixel circuit portion 283 includes a plurality of pixel circuits 283a arranged periodically. One pixel circuit 283a is a circuit for controlling light emission of three light-emitting devices included in one pixel 284a. One pixel circuit 283a may be provided with three circuits for controlling light emission of one light-emitting device. For example, the pixel circuit 283a can include at least one selection transistor, one current control transistor (driving transistor), and a capacitor for one light-emitting device. In that case, a gate signal is input to a gate of the selection transistor, and a source signal is input to a source of the selection transistor. Thus, an active-matrix display panel is achieved.

The circuit portion 282 includes a circuit for driving the pixel circuits 283a in the pixel circuit portion 283. For example, the circuit portion 282 preferably includes one or both of a gate line driver circuit and a source line driver circuit. The circuit portion 282 may further include at least one of an arithmetic circuit, a memory circuit, a power supply circuit, and the like. In addition, a transistor provided in the circuit portion 282 may constitute part of the pixel circuit 283a. That is, the pixel circuit 283a may be constituted by a transistor included in the pixel circuit portion 283 and a transistor included in the circuit portion 282.

The FPC 290 functions as a wiring for supplying a video signal, a power supply potential, and the like to the circuit portion 282 from the outside. In addition, an IC may be mounted on the FPC 290.

The display module 280 can have a structure where one or both of the pixel circuit portion 283 and the circuit portion 282 are provided to be stacked below the pixel portion 284; thus, the aperture ratio (effective display area ratio) of the display portion 281 can be significantly high. For example, the aperture ratio of the display portion 281 can be greater than or equal to 40% and less than 100%, preferably greater than or equal to 50% and less than or equal to 95%, further preferably greater than or equal to 60% and less than or equal to 95%. Furthermore, the pixels 284a can be arranged extremely densely and thus the display portion 281 can have an extremely high resolution. For example, the pixels 284a are preferably arranged in the display portion 281 with a resolution higher than or equal to 2000 ppi, preferably higher than or equal to 3000 ppi, further preferably higher than or equal to 5000 ppi, still further preferably higher than or equal to 6000 ppi, and lower than or equal to 20000 ppi or lower than or equal to 30000 ppi.

Such a display module 280 has an extremely high resolution, and thus can be suitably used for a VR device such as a head-mounted display or a glasses-type AR device. For example, even in the case of a structure where the display portion of the display module 280 is seen through a lens, pixels of the extremely-high-resolution the display portion 281 included in the display module 280 are not seen even when the display portion is enlarged by the lens, so that display providing a high sense of immersion can be performed. Without being limited thereto, the display module 280 can be also suitably used for an electronic device having a relatively small display portion. For example, the display module 280 can be suitably used for a display portion of a wearable electronic device such as a wristwatch.

### Display Panel 200A

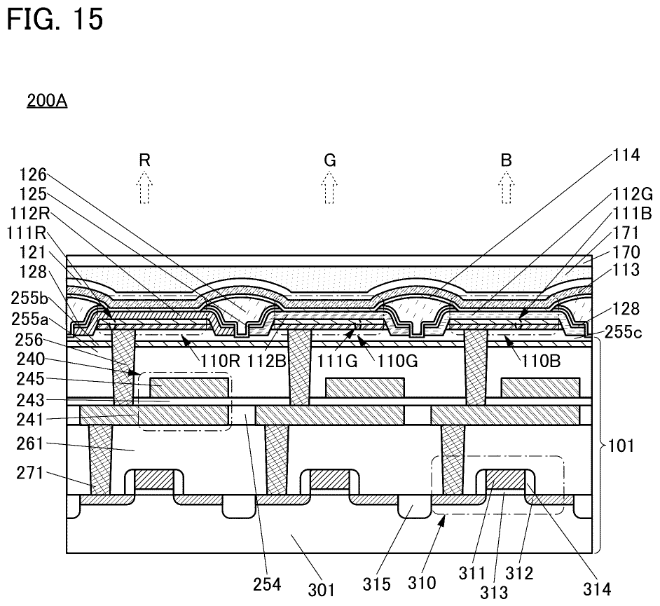

The display panel 200A illustrated in FIG. 15 includes a substrate 301, the light-emitting elements 110R, 110G, and 110B, a capacitor 240, and a transistor 310.

The substrate 301 corresponds to the substrate 291 in FIG. 14A and FIG. 14B.

The transistor 310 is a transistor that includes a channel formation region in the substrate 301. As the substrate 301, a semiconductor substrate such as a single crystal silicon substrate can be used, for example. The transistor 310 includes part of the substrate 301, a conductive layer 311, a low-resistance region 312, an insulating layer 313, and an insulating layer 314. The conductive layer 311 functions as a gate electrode. The insulating layer 313 is positioned between the substrate 301 and the conductive layer 311 and functions as a gate insulating layer. The low-resistance region 312 is a region where the substrate 301 is doped with an impurity, and functions as one of a source and a drain. The insulating layer 314 is provided to cover the side surface of the conductive layer 311.

In addition, an element isolation layer 315 is provided between two adjacent transistors 310 to be embedded in the substrate 301.

Furthermore, an insulating layer 261 is provided to cover the transistors 310, and the capacitor 240 is provided over the insulating layer 261.

The capacitor 240 includes a conductive layer 241, a conductive layer 245, and an insulating layer 243 positioned therebetween. The conductive layer 241 functions as one electrode of the capacitor 240, the conductive layer 245 functions as the other electrode of the capacitor 240, and the insulating layer 243 functions as a dielectric of the capacitor 240.

The conductive layer 241 is provided over the insulating layer 261 and is embedded in an insulating layer 254. The conductive layer 241 is electrically connected to one of the source and the drain of the transistor 310 through a plug 271 embedded in the insulating layer 261. The insulating layer 243 is provided to cover the conductive layer 241. The conductive layer 245 is provided in a region overlapping with the conductive layer 241 with the insulating layer 243 therebetween.

An insulating layer 255a is provided to cover the capacitor 240, an insulating layer 255b is provided over the insulating layer 255a, and an insulating layer 255c is provided over the insulating layer 255b.

An inorganic insulating film can be suitably used for each of the insulating layer 255a, the insulating layer 255b, and the insulating layer 255c. For example, it is preferable that a silicon oxide film be used for each of the insulating layer 255a and the insulating layer 255c and that a silicon nitride film be used for the insulating layer 255b. This enables the insulating layer 255b to function as an etching protective film. Although this embodiment shows an example where the insulating layer 255c is partly etched and a concave portion is formed, the depressed portion is not necessarily provided in the insulating layer 255c.

The light-emitting element 110R, the light-emitting element 110G, and the light-emitting element 110B are provided over the insulating layer 255c. Embodiment 2 can be referred to for the structures of the light-emitting element 110R, the light-emitting element 110G, and the light-emitting element 110B.

Since the light-emitting devices for different emission colors are separately formed in the display panel 200A, the difference between the chromaticity at low luminance emission and that at high luminance emission is small. Furthermore, since the organic layers 112R, 112G, and 112B are apart from each other, crosstalk generated between adjacent subpixels can be inhibited even when the display panel has a high resolution. It is thus possible to achieve a display panel that has a high resolution and high display quality.

In a region between adjacent light-emitting elements, the insulating layer 125, the resin layer 126, and the layer 128 are provided.

The pixel electrode 111R, the pixel electrode 111G, and the pixel electrode 111B of the light-emitting elements are each electrically connected to one of the source and the drain of the transistor 310 through a plug 256 that is embedded in the insulating layer 255a, the insulating layer 255b, and the insulating layer 255c, the conductive layer 241 that is embedded in the insulating layer 254, and the plug 271 that is embedded in the insulating layer 261. The top surface of the insulating layer 255c and the top surface of the plug 256 are level with or substantially level with each other. A variety of conductive materials can be used for the plugs.

In addition, the protective layer 121 is provided over the light-emitting elements 110R, 110G, and 110B. A substrate 170 is attached onto the protective layer 121 with an adhesive layer 171.

An insulating layer covering an end portion of the top surface of the pixel electrode 111 is not provided between two adjacent pixel electrodes 111. Thus, the distance between adjacent light-emitting elements can be extremely shortened. Accordingly, the display panel can have a high resolution or a high definition.

### Display Panel 200B

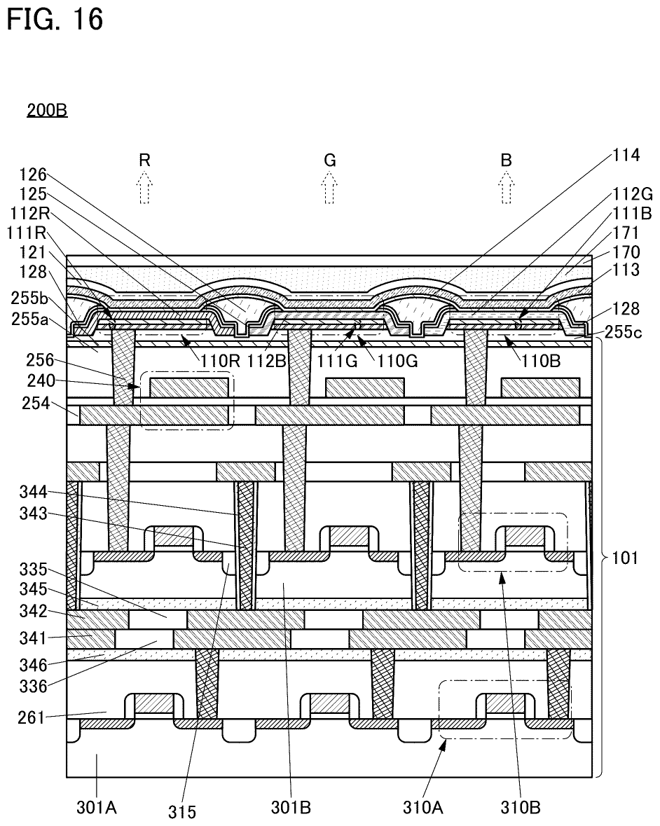

The display panel 200B illustrated in FIG. 16 has a structure where a transistor 310A and a transistor 310B in each of which a channel is formed in a semiconductor substrate are stacked. Note that in the following description of the display panel, the description of portions similar to those of the above display panel is omitted in some cases.

The display panel 200B has a structure where a substrate 301B provided with the transistor 310B, the capacitor 240, and the light-emitting devices is attached to a substrate 301A provided with the transistors 310A.

Here, an insulating layer 345 is provided on the bottom surface of the substrate 301B, and an insulating layer 346 is provided over the insulating layer 261 provided over the substrate 301A. The insulating layers 345 and 346 are insulating layers functioning as protective layers and can inhibit diffusion of impurities into the substrate 301B and the substrate 301A. For the insulating layers 345 and 346, an inorganic insulating film that can be used for the protective layer 121 or an insulating layer 332 can be used.

The substrate 301B is provided with a plug 343 that penetrates the substrate 301B and the insulating layer 345. Here, an insulating layer 344 functioning as a protective layer is preferably provided to cover the side surface of the plug 343.

A conductive layer 342 is provided under the insulating layer 345 on the substrate 301B. The conductive layer 342 is embedded in an insulating layer 335, and the bottom surfaces of the conductive layer 342 and the insulating layer 335 are planarized. Furthermore, the conductive layer 342 is electrically connected to the plug 343.

A conductive layer 341 is provided over the insulating layer 346 over the substrate 301A. The conductive layer 341 is embedded in an insulating layer 336, and the top surfaces of the conductive layer 341 and the insulating layer 336 are planarized.

The same conductive material is preferably used for the conductive layer 341 and the conductive layer 342. A metal film including an element selected from Al, Cr, Cu, Ta, Ti, Mo, and W, a metal nitride film including the above element as a component (a titanium nitride film, a molybdenum nitride film, or a tungsten nitride film), or the like can be used, for example. Copper is particularly preferably used for the conductive layer 341 and the conductive layer 342. Accordingly, it is possible to employ a Cu—to—Cu (copper-to-copper) direct bonding technique (a technique for achieving electrical continuity by connecting Cu (copper) pads to each other).

### Display Panel 200C

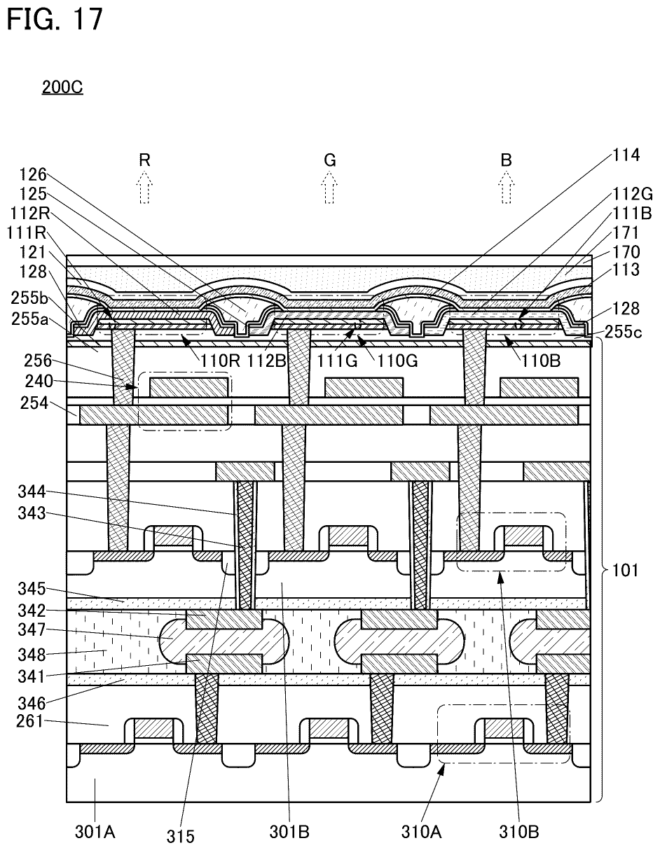

The display panel 200C illustrated in FIG. 17 has a structure where the conductive layer 341 and the conductive layer 342 are bonded to each other through a bump 347.

As illustrated in FIG. 17, providing the bump 347 between the conductive layer 341 and the conductive layer 342 enables the conductive layer 341 and the conductive layer 342 to be electrically connected to each other. The bump 347 can be formed with the use of a conductive material containing gold (Au), nickel (Ni), indium (In), tin (Sn), or the like, for example. As another example, solder is used for the bump 347 in some cases. In addition, an adhesive layer 348 may be provided between the insulating layer 345 and the insulating layer 346. Furthermore, in the case where the bump 347 is provided, a structure without the insulating layer 335 and the insulating layer 336 may be employed.

### Display Panel 200D

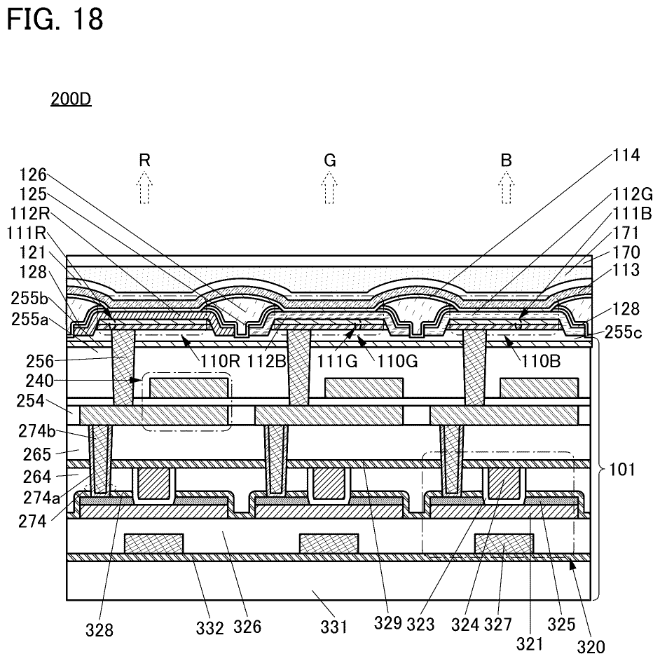

The display panel 200D illustrated in FIG. 18 differs from the display panel 200A mainly in a transistor structure.

A transistor 320 is a transistor (an OS transistor) in which a metal oxide (also referred to as an oxide semiconductor) is used for a semiconductor layer where a channel is formed.

The transistor 320 includes a semiconductor layer 321, an insulating layer 323, a conductive layer 324, a pair of conductive layers 325, an insulating layer 326, and a conductive layer 327.

A substrate 331 corresponds to the substrate 291 in FIG. 14A and FIG. 14B.

The insulating layer 332 is provided over the substrate 331. The insulating layer 332 functions as a barrier layer that prevents diffusion of impurities such as water or hydrogen from the substrate 331 into the transistor 320 and release of oxygen from the semiconductor layer 321 to the insulating layer 332 side. As the insulating layer 332, for example, a film in which hydrogen or oxygen is less likely to diffuse than in a silicon oxide film, such as an aluminum oxide film, a hafnium oxide film, or a silicon nitride film, can be used.

The conductive layer 327 is provided over the insulating layer 332, and the insulating layer 326 is provided to cover the conductive layer 327. The conductive layer 327 functions as a first gate electrode of the transistor 320, and part of the insulating layer 326 functions as a first gate insulating layer. An oxide insulating film such as a silicon oxide film is preferably used for at least part of the insulating layer 326 that is in contact with the semiconductor layer 321. The top surface of the insulating layer 326 is preferably planarized.

The semiconductor layer 321 is provided over the insulating layer 326. The semiconductor layer 321 preferably includes a metal oxide (also referred to as an oxide semiconductor) film exhibiting semiconductor characteristics. The pair of conductive layers 325 is provided on and in contact with the semiconductor layer 321, and functions as a source electrode and a drain electrode.

An insulating layer 328 is provided to cover the top and side surfaces of the pair of conductive layers 325, the side surface of the semiconductor layer 321, and the like, and an insulating layer 264 is provided over the insulating layer 328. The insulating layer 328 functions as a barrier layer that prevents diffusion of impurities such as water or hydrogen from the insulating layer 264 or the like into the semiconductor layer 321 and release of oxygen from the semiconductor layer 321. For the insulating layer 328, an insulating film similar to the insulating layer 332 can be used.

An opening reaching the semiconductor layer 321 is provided in the insulating layer 328 and the insulating layer 264. The conductive layer 324 and the insulating layer 323 that is in contact with the top surface of the semiconductor layer 321 are embedded in the opening. The conductive layer 324 functions as a second gate electrode, and the insulating layer 323 functions as a second gate insulating layer.

The top surface of the conductive layer 324, the top surface of the insulating layer 323, and the top surface of the insulating layer 264 are subjected to planarization treatment so that they are level with or substantially level with each other, and an insulating layer 329 and an insulating layer 265 are provided to cover these layers.

The insulating layer 264 and the insulating layer 265 each function as an interlayer insulating layer. The insulating layer 329 functions as a barrier layer that prevents diffusion of impurities such as water or hydrogen from the insulating layer 265 or the like into the transistor 320. For the insulating layer 329, an insulating film similar to the insulating layer 328 and the insulating layer 332 can be used.

A plug 274 electrically connected to one of the pair of conductive layers 325 is provided to be embedded in the insulating layer 265, the insulating layer 329, and the insulating layer 264. Here, the plug 274 preferably includes a conductive layer 274a that covers the side surfaces of openings in the insulating layer 265, the insulating layer 329, the insulating layer 264, and the insulating layer 328 and part of the top surface of the conductive layer 325, and a conductive layer 274b in contact with the top surface of the conductive layer 274a. In that case, a conductive material in which hydrogen and oxygen are less likely to diffuse is preferably used for the conductive layer 274a.

Note that there is no particular limitation on the structures of the transistors included in the display panel of this embodiment. For example, a planar transistor, a staggered transistor, an inverted staggered transistor, or the like can be used. In addition, the transistor structure may be either a top-gate structure or a bottom-gate structure. Alternatively, gates may be provided above and below a semiconductor layer where a channel is formed.

A structure where the semiconductor layer where a channel is formed is interposed between two gates is employed for the transistor 320. The two gates may be connected to each other and supplied with the same signal to drive the transistor. Alternatively, a potential for controlling the threshold voltage may be supplied to one of the two gates and a potential for driving may be supplied to the other of the two gates to control the threshold voltage of the transistor.

There is no particular limitation on the crystallinity of a semiconductor material used for the semiconductor layer of the transistor, and any of an amorphous semiconductor, a single crystal semiconductor, and a semiconductor having crystallinity other than single crystal (a microcrystalline semiconductor, a polycrystalline semiconductor, or a semiconductor partly including crystal regions) may be used. A single crystal semiconductor or a semiconductor having crystallinity is preferably used because degradation of the transistor characteristics can be inhibited.

The bandgap of a metal oxide used for the semiconductor layer of the transistor is preferably greater than or equal to 2 eV, further preferably greater than or equal to 2.5 eV. The use of a metal oxide having a wide bandgap can reduce the off-state current of the OS transistor.

A metal oxide preferably contains at least indium or zinc, and further preferably contains indium and zinc. A metal oxide preferably contains indium, M (M is one or more kinds selected from gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example.

Alternatively, the semiconductor layer of the transistor may contain silicon. Examples of silicon include amorphous silicon and crystalline silicon (low-temperature polysilicon, single crystal silicon, or the like).

Examples of the metal oxide that can be used for the semiconductor layer include indium oxide, gallium oxide, and zinc oxide. In addition, the metal oxide preferably contains two or three kinds selected from indium, the element M, and zinc. Note that the element M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium. In particular, the element M is preferably one or more kinds selected from aluminum, gallium, yttrium, and tin.

It is particularly preferable that an oxide containing indium, gallium, and zinc (also referred to as IGZO) be used as the metal oxide used for the semiconductor layer. Alternatively, it is preferable to use an oxide containing indium, tin, and zinc (also referred to as ITZO (registered trademark)). Alternatively, it is preferable to use an oxide containing indium, gallium, tin, and zinc. Alternatively, it is preferable to use an oxide containing indium, aluminum, and zinc (also referred to as IAZO). Alternatively, it is preferable to use an oxide containing indium, aluminum, gallium, and zinc (also referred to as IAGZO).

In the case where the metal oxide used for the semiconductor layer is an In-M-Zn oxide, the atomic proportion of In is preferably higher than or equal to the atomic proportion of M in the In-M-Zn oxide. Examples of the atomic ratio of the metal elements in such an In-M-Zn oxide include In:M:Zn=1:1:1 or a composition in the neighborhood thereof, In:M:Zn=1:1:1.2 or a composition in the neighborhood thereof, In:M:Zn=1:3:2 or a composition in the neighborhood thereof, In:M:Zn=1:3:4 or a composition in the neighborhood thereof, In:M:Zn=2:1:3 or a composition in the neighborhood thereof, In:M:Zn=3:1:2 or a composition in the neighborhood thereof, In:M:Zn=4:2:3 or a composition in the neighborhood thereof, In:M:Zn=4:2:4.1 or a composition in the neighborhood thereof, In:M:Zn=5:1:3 or a composition in the neighborhood thereof, In:M:Zn=5:1:6 or a composition in the neighborhood thereof, In:M:Zn=5:1:7 or a composition in the neighborhood thereof, In:M:Zn=5:1:8 or a composition in the neighborhood thereof, In:M:Zn=6:1:6 or a composition in the neighborhood thereof, and In:M:Zn=5:2:5 or a composition in the neighborhood thereof. Note that a composition in the neighborhood includes the range of ±30% of an intended atomic ratio.

For example, when the atomic ratio is described as In:Ga:Zn=4:2:3 or a composition in the neighborhood thereof, the case is included where Ga is greater than or equal to 1 and less than or equal to 3 and Zn is greater than or equal to 2 and less than or equal to 4 with In being 4. In addition, when the atomic ratio is described as In:Ga:Zn=5:1:6 or a composition in the neighborhood thereof, the case is included where Ga is greater than 0.1 and less than or equal to 2 and Zn is greater than or equal to 5 and less than or equal to 7 with In being 5. Furthermore, when the atomic ratio is described as In:Ga:Zn=1:1:1 or a composition in the neighborhood thereof, the case is included where Ga is greater than 0.1 and less than or equal to 2 and Zn is greater than 0.1 and less than or equal to 2 with In being 1.

Alternatively, the semiconductor layer may include two or more metal oxide layers having different compositions. For example, a stacked-layer structure of a first metal oxide layer having In:M:Zn=1:3:4 [atomic ratio] or a composition in the neighborhood thereof and a second metal oxide layer that is provided over the first metal oxide layer and has In:M:Zn=1:1:1 [atomic ratio] or a composition in the neighborhood thereof can be suitably used. In particular, gallium or aluminum is preferably used as the element M.

Alternatively, a stacked-layer structure or the like of one selected from indium oxide, indium gallium oxide, and IGZO, and one selected from IAZO, IAGZO, and ITZO (registered trademark) may be used, for example.

Examples of an oxide semiconductor having crystallinity include a CAAC (c-axis aligned crystalline)-OS and an nc (nanocrystalline)-OS.

An OS transistor has extremely higher field-effect mobility than a transistor using amorphous silicon. In addition, the OS transistor has extremely low leakage current between a source and a drain in an off state (also referred to as off-state current), and charge accumulated in a capacitor that is connected in series with the transistor can be retained for a long period. Furthermore, the power consumption of the display panel can be reduced with the use of the OS transistor.

In addition, to increase the emission luminance of the light-emitting device included in the pixel circuit, the amount of current flowing through the light-emitting device needs to be increased. To increase the amount of current, the source-drain voltage of a driving transistor included in the pixel circuit needs to be increased. Since the OS transistor has higher breakdown voltage between the source and the drain than a Si transistor, high voltage can be applied between the source and the drain of the OS transistor. Accordingly, when an OS transistor is used as the driving transistor included in the pixel circuit, the amount of current flowing through the light-emitting device can be increased, so that the emission luminance of the light-emitting device can be increased.

In addition, when transistors operate in a saturation region, a change in source-drain current relative to a change in gate-source voltage is smaller in an OS transistor than in a Si transistor. Accordingly, when an OS transistor is used as the driving transistor included in the pixel circuit, the amount of current flowing between the source and the drain can be finely set by a change in gate-source voltage; thus, the amount of current flowing through the light-emitting device can be controlled. Therefore, the number of gray levels in the pixel circuit can be increased.

In addition, regarding saturation characteristics of current flowing when a transistor operates in a saturation region, even in the case where the source-drain voltage of an OS transistor gradually increases, more stable current (saturation current) can be fed through the OS transistor than through a Si transistor. Thus, with the use of an OS transistor as the driving transistor, stable current can be fed through the light-emitting device even when the current-voltage characteristics of EL devices vary, for example. In other words, when the OS transistor operates in the saturation region, the source-drain current hardly changes even with an increase in the source-drain voltage; thus, the emission luminance of the light-emitting device can be stable.

As described above, with the use of an OS transistor as the driving transistor included in the pixel circuit, it is possible to achieve “reduction in power consumption,” “increase in emission luminance,” “increase in the number of gray levels,” “inhibition of variation in light-emitting devices,” and the like.

### Display Panel 200E

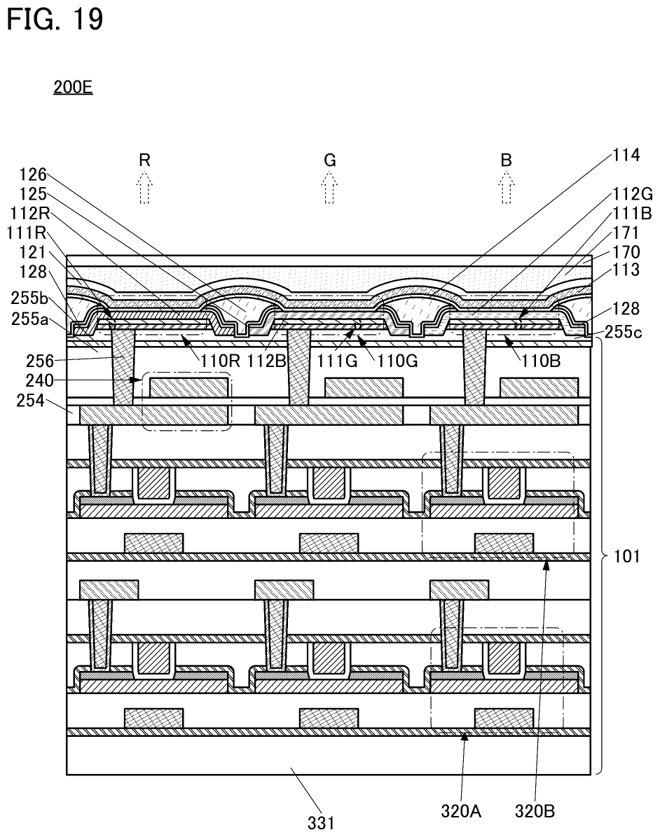

The display panel 200E illustrated in FIG. 19 has a structure where a transistor 320A and a transistor 320B each including an oxide semiconductor in a semiconductor where a channel is formed are stacked.

The display panel 200D can be referred to for the transistor 320A, the transistor 320B, and other peripheral structures.

Note that although the structure where two transistors each including an oxide semiconductor are stacked is described here, the present invention is not limited thereto. For example, a structure may be employed where three or more transistors are stacked.

### Display Panel 200F

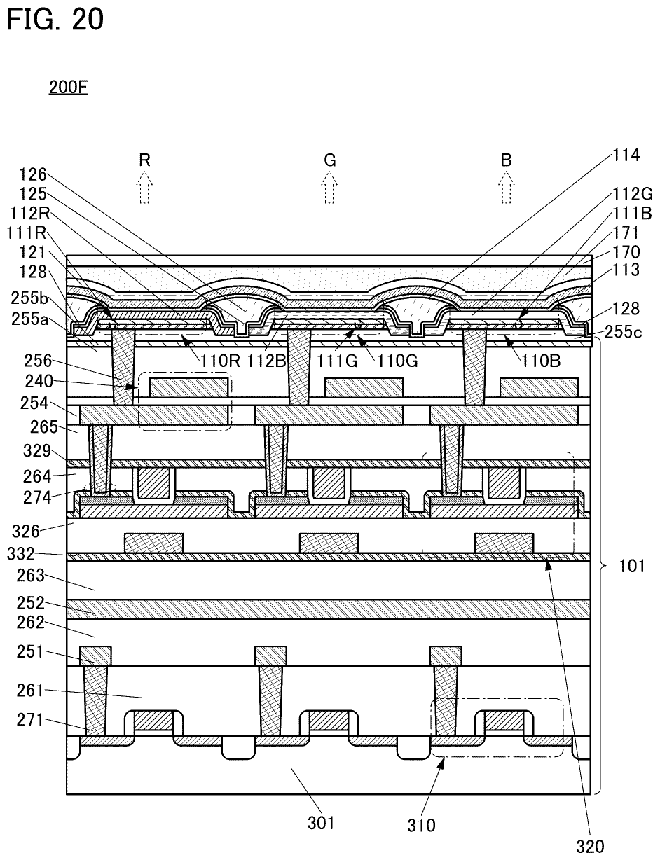

The display panel 200F illustrated in FIG. 20 has a structure in which the transistor 310 having a channel formed in the substrate 301 and the transistor 320 including a metal oxide in a semiconductor layer where a channel is formed are stacked.

The insulating layer 261 is provided to cover the transistor 310, and a conductive layer 251 is provided over the insulating layer 261. In addition, an insulating layer 262 is provided to cover the conductive layer 251, and a conductive layer 252 is provided over the insulating layer 262. The conductive layer 251 and the conductive layer 252 each function as a wiring. Furthermore, an insulating layer 263 and the insulating layer 332 are provided to cover the conductive layer 252, and the transistor 320 is provided over the insulating layer 332. Moreover, the insulating layer 265 is provided to cover the transistor 320, and the capacitor 240 is provided over the insulating layer 265. The capacitor 240 and the transistor 320 are electrically connected to each other through the plug 274.

The transistor 320 can be used as a transistor included in the pixel circuit. In addition, the transistor 310 can be used as a transistor included in the pixel circuit or a transistor included in a driver circuit (a gate line driver circuit or a source line driver circuit) for driving the pixel circuit. Furthermore, the transistor 310 and the transistor 320 can be used as transistors included in a variety of circuits such as an arithmetic circuit or a memory circuit.

With such a structure, not only the pixel circuit but also the driver circuit and the like can be formed directly under the light-emitting devices; thus, the display panel can be downsized as compared with the case where the driver circuit is provided around a display region.

### Display Panel 200G

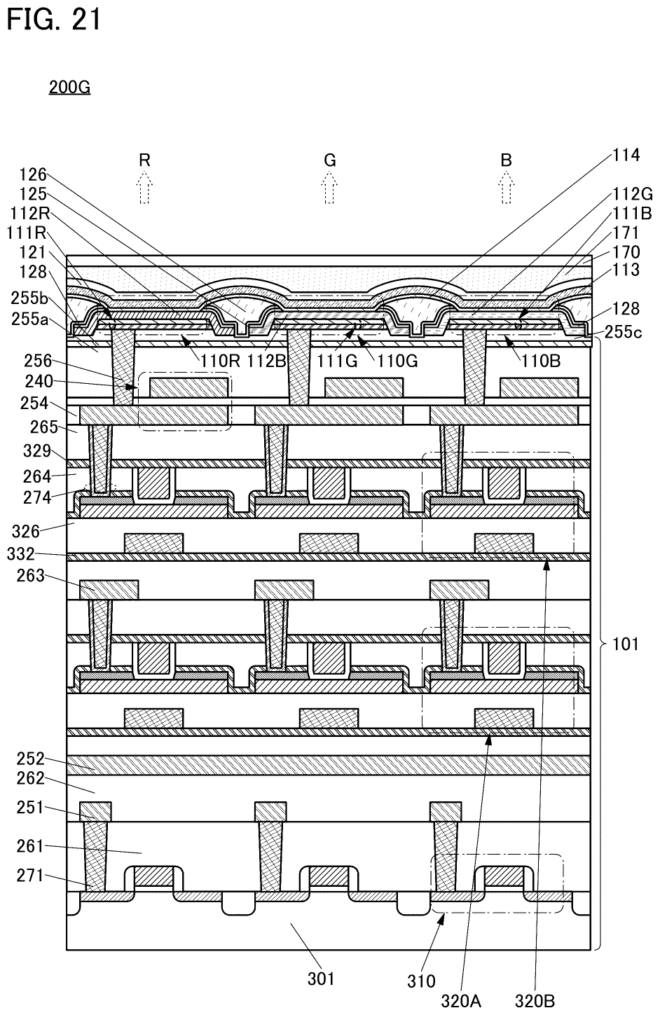

The display panel 200G illustrated in FIG. 21 has a structure in which the transistor 310 having a channel formed in the substrate 301 and the transistor 320A and the transistor 320B each including a metal oxide in a semiconductor layer where a channel is formed are stacked.

The transistor 320A can be used as a transistor included in the pixel circuit. In addition, the transistor 310 can be used as a transistor included in the pixel circuit or a transistor included in a driver circuit (a gate line driver circuit or a source line driver circuit) for driving the pixel circuit. The transistor 320B may be used as a transistor included in the pixel circuit or a transistor included in the driver circuit. Furthermore, the transistor 310, the transistor 320A, and the transistor 320B can be used as transistors included in a variety of circuits such as an arithmetic circuit or a memory circuit.

At least part of this embodiment can be implemented in combination with the other embodiments described in this specification as appropriate.

### REFERENCE NUMERALS

10: eye, 30: display device, 31: display panel, 32: linear polarizing plate, 33: retardation plate, 40: optical device, 41: half mirror, 42: lens, 43: retardation plate, 44: reflective polarizing plate, 45: lens, 46: dark filter, 70: pixel, 71: subpixel, 74: pixel array, 75: circuit, 76: circuit, 77: layer, 78: layer, 79: layer, 90: housing, 91: band, 92: display unit, 100a: display panel, 100b: display panel, 100: display panel, 101: substrate, 110a: light-emitting element, 110B: light-emitting element, 110b: light-emitting element, 110c: light-emitting element, 110G: light-emitting element, 110R: light-emitting element, 110W: light-emitting element, 110: light-emitting element, 111B: pixel electrode, 111C: connection electrode, 111G: pixel electrode, 111R: pixel electrode, 111: pixel electrode, 112B: organic layer, 112G: organic layer, 112R: organic layer, 112W: organic layer, 112: organic layer, 113: common electrode, 114: common layer, 115B: conductive layer, 115G: conductive layer, 115R: conductive layer, 116B: coloring layer, 116G: coloring layer, 116R: coloring layer, 121: protective layer, 122: insulating layer, 123: insulating layer, 124a: pixel, 124b: pixel, 125: insulating layer, 126: resin layer, 128: layer, 140: connection portion, 150: pixel, 170: substrate, 171: adhesive layer, 200A: display panel, 200B: display panel, 200C: display panel, 200D: display panel, 200E: display panel, 200F: display panel, 200G: display panel, 240: capacitor, 241: conductive layer, 243: insulating layer, 245: conductive layer, 251: conductive layer, 252: conductive layer, 254: insulating layer, 255a: insulating layer, 255b: insulating layer, 255c: insulating layer, 256: plug, 261: insulating layer, 262: insulating layer, 263: insulating layer, 264: insulating layer, 265: insulating layer, 271: plug, 274a: conductive layer, 274b: conductive layer, 274: plug, 280: display module, 281: display portion, 282: circuit portion, 283a: pixel circuit, 283: pixel circuit portion, 284a: pixel, 284: pixel portion, 285: terminal portion, 286: wiring portion, 290: FPC, 291: substrate, 292: substrate, 301A: substrate, 301B: substrate, 301: substrate, 310A: transistor, 310B: transistor, 310: transistor, 311: conductive layer, 312: low-resistance region, 313: insulating layer, 314: insulating layer, 315: element isolation layer, 320A: transistor, 320B: transistor, 320: transistor, 321: semiconductor layer, 323: insulating layer, 324: conductive layer, 325: conductive layer, 326: insulating layer, 327: conductive layer, 328: insulating layer, 329: insulating layer, 331: substrate, 332: insulating layer, 335: insulating layer, 336: insulating layer, 341: conductive layer, 342: conductive layer, 343: plug, 344: insulating layer, 345: insulating layer, 346: insulating layer, 347: bump, 348: adhesive layer

1. An electronic device comprising:
a display panel and an optical device,
wherein the optical device is configured to converge light emitted from the display panel and emit the light to a user's eye,
wherein the optical device is configured to partly decrease luminance of the light emitted from the display panel, and
wherein a luminance decrease rate of the light emitted from the display panel is continuously increased from a central region of a visual field to an end of the visual field.

2. The electronic device according to claim 1,
wherein the optical device comprises a half mirror, and
wherein the half mirror comprises a region in which transmittance is continuously decreased from the inside toward the outside.

3. The electronic device according to claim 1,
wherein the optical device comprises a dark filter, and
wherein the dark filter comprises a region in which transmittance is continuously decreased from the inside toward the outside.

4. The electronic device according to claim 1,
wherein a range of the central region is greater than or equal to 20° and less than or equal to 40° comprising a center of the visual field.

5. The electronic device according to claim 1,
wherein, when transmittance of the optical device corresponding to the central region is 1, transmittance of the optical device corresponding to the end of the visual field is higher than or equal to 0.3 and lower than or equal to 0.7.

6. The electronic device according to claim 1,
wherein the display panel comprises an organic EL element.

7. An electronic device comprising:
a display panel; and
an optical device comprising a half mirror, a first lens, a retardation plate, a reflective polarizing plate, and a second lens overlapping with each other,
wherein the optical device is configured to converge light emitted from the display panel and emit the light to a user's eye,
wherein the optical device is configured to partly decrease luminance of the light emitted from the display panel, and
wherein transmittance of the half mirror is continuously decreased from a central region of a visual field to an end of the visual field.

8. The electronic device according to claim 7,
wherein the display panel comprises an organic EL element.
